(19) United States
(12) Patent Application Publication
(10) Pub. No.: US 2012/0189752 A1
(43) Pub. Date: Jul. 26, 2012

(54) DAIRY PRODUCT AND PROCESS

(75) Inventors: David Illingworth, Palmerston North (NZ); Patrick William Mary Janssen, Palmerston North (NZ); Philip Arthur Euan Cant, Palmerston North (NZ); Graeme Robert Stephens, Palmerston North (NZ)

(73) Assignee: FONTERRA CO-OPERATIVE GROUP LIMITED, Auckland (NZ)

(21) Appl. No.: 13/333,803

(22) Filed: Dec. 21, 2011

Related U.S. Application Data
(63) Continuation-in-part of application No. 12/667,946, filed on Mar. 9, 2010.

(30) Foreign Application Priority Data
Jul. 13, 2007 (NZ) 556528

(51) Int. Cl. A23L 1/226; A23G 1/36; A23G 3/40

(52) U.S. Cl. 426/583; 426/650; 426/580; 426/588; 426/631

(57) ABSTRACT

The present invention relates to methods of making flavour concentrates, in particular lipid, condensed and solids flavour concentrates, together with the flavour concentrates produced thereby. The flavour concentrates produced by the methods of the present invention have improved flavour and other characteristics and have wide application in the production of foods and beverages.

### REFERENCE TO RELATED APPLICATIONS

This application is a Continuation-in-Part of U.S. patent application Ser. No. 12/667,946 filed on Mar. 9, 2010, which is a National Phase Application of International Application PCT/NZ2008/000168, filed Jul. 14, 2008, and claims priority to New Zealand Patent Application number 556528 filed on Jul. 13, 2007. Each of the priority applications is hereby incorporated by reference in its entirety.

### FIELD OF THE INVENTION

The present invention relates to a method of making lipid, condensed and solids flavour concentrates with improved flavour characteristics and the products thereof.

### BACKGROUND TO THE INVENTION

Butter has long been used in cooking for enhancement of flavour. Other cream or butter-derived milkfat products, such as Anhydrous milkfat (AMF), butter-oil (BO), clarified butter, Beurre noir, Beurre-Noisette and ghee, have long been known and are used to impart a flavour to a food being prepared. The flavour characteristics of these milkfat products are frequently deemed by consumers to be superior to those of other oils and fats. When compared with butter, AMF, BO and clarified butter, the flavour and aroma profiles of traditional Ghee, Beurre noir and Beurre-Noisette are more intense and have flavours and aromas that are more like those derived from cooking of food.

Traditional ghee is made by heating a water-containing lipid material such as butter or cream in an open pan to boil off the water followed by separation of the fat phase (the ghee) from the solids-not-fat phase. Butter is most commonly used in the preparation of ghees. Beurre noir and beurre-noisette are similar products used in French cuisine. Traditional ghee, beurre noir and beurre-noisette are valued for the intense flavours they impart when used in cooking, relative to other milkfat products. However, they are commonly produced on a small scale (typically in the kitchen or by cottage industry), as the fouling of heating surfaces with solids-not-fat that occurs during heating of cream has been an unresolved obstacle to industrial-scale manufacture. In addition, overheating of the product causes undesirable flavours and control of the heating process and the end point is difficult, such that processes to date have been unable to produce products with consistent characteristics. These factors have all acted to inhibit industrial-scale manufacture. As a result, much of the commercially available ghee is simply AMF or BO that lacks the intense flavour that makes traditional ghee, beurre noir and beurre-noisette so desirable.

Wadhwa, Bindal and Jain (“Simulation of ghee flavour in butter oil” (1977). Indian Journal of Dairy Science, 30:4; 314-318) recognise the poor flavour of imitation ghee products prepared from AMF or butter oil, and disclose the simulation of traditional ghee flavour in BO by first mixing BO with 5% cultured skim milk powder (spray dried dahi) and then heating the mixture to 120° C. for 3 minutes to obtain a caramelised flavour in the product similar to that of traditional desi ghee. Similarly mixing 20% dahi with the BO and heating to 120° C. for 3 minutes is also described as a means mimicking desi ghee flavour.

Wadhwa and Jain (“Production of ghee from butter oil—A review” (1991), Indian Journal of Dairy Science, 44:6; 372-374) report methods of producing ghee from butter oil. One such method reported is to add dahi to BO, mixing, and then heat the mixture at 120° C. for 3 minutes. An alternate method reported therein involves the addition of ghee residue (fat, protein, water and ash) to the heated dahi-BO mix. The flavours produced by these methods were stated to be “strong to mild curdy”, “strong to mild cooked”, “strong curdy+mild cooked”, “mild curdy+mild cooked”, “mild curdy+strong cooked” and “strong curdy+strong cooked”.

Milkfat contains high levels of saturated fat. Therefore, butter, AMF, BO, clarified butter, beurre noir, beurre-noisette and ghee contribute significant amounts of saturated fat to the diet as well as being high in fat. The American Heart Association recommends choosing dishes prepared without ghee (see http://www.americanheart.org/presenter.jhtml? identifier=1097) and nutritional guidelines commonly recommend a reduction in total and saturated fat intakes. However, removing butters and clarified butters from foods can cause the foods to lose their essential ethnic flavour and aroma characteristics and a general loss in flavour and aroma. Therefore, it would be desirable to provide a fat based flavour concentrate with improved flavour characteristics that can be used in smaller quantities than traditional butters and clarified butters to improve the nutritional properties of the food in which it is used without a loss of flavour or aroma. Furthermore, good quality ghee is expensive compared to presently-available imitations. It would be desirable to provide cost-effective alternatives to high quality ghee, preferably without sacrificing desired flavour characteristics.

It is an object of the present invention to provide one or more flavour concentrates with improved flavour characteristics or to at least provide the public with a useful choice.

### SUMMARY OF THE INVENTION

In one aspect the invention relates to a method of making a flavour concentrate, the method comprising
(1) providing a lipid material,
(2) providing an aqueous material, the aqueous material comprising one or more sugars and one or more primary or secondary amines,
(3) heating the lipid material to a first temperature at or above the boiling point of the aqueous material,
(4) admixing the heated lipid material and the aqueous material, and
(5) maintaining the mixture for a period at a temperature at least until substantially all the water present in the aqueous material is vapourised.

In one embodiment, the method additionally comprises after step (5) the step:
(6) maintaining the mixture for a second period at a second temperature that is different to the first temperature.

In various embodiments, the temperature at which the mixture is maintained in step (5) is at or about the first temperature, or is another temperature below or above the first temperature.

In various embodiments, the second temperature is higher than the first temperature, or is higher than the temperature at which the mixture is maintained in step (5), or is higher than both the first temperature and the temperature at which the mixture is maintained in step (5). In other embodiments, the second temperature is lower than the first temperature, or is lower than the temperature at which the mixture is maintained in step (5), or is lower than both the first temperature and the temperature at which the mixture is maintained in step (5).

In preferred embodiments, the aqueous material is heated, preferably at or to at least about 40, 45, 50, 55, 60, 65, 70, 75, 80, 85, 90 or about 95 degrees Celsius and useful ranges may be selected between any of these forgoing values (for example, from about 40 to about 70 degrees Celsius).

In preferred embodiments, the method additionally comprises after step (5) or preferably after step (6) one or more of the following optional steps:
(7) the mixture is cooled,
(8) the mixture is passed through a separation device to remove solid matter,
(9) the mixture is packaged.

In various embodiments, the lipid material comprises, consists essentially of or consists of an edible oil, an animal fat, a dairy fat, a milkfat, a modified edible oil, a modified animal fat, a modified dairy fat, a modified milkfat, or any mixture thereof.

Preferably, the aqueous material contains one or more primary or secondary amines that are present as one or more amino acids, more preferably as one or more peptides or one or more proteins.

In certain embodiments the aqueous material may additionally comprise one or more lipids. Preferably, the aqueous material comprises, consists essentially of or consists of a dairy material or a modified dairy material or a fermentate, and may contain a significant proportion of lipid dispersed within it.

Preferably, the aqueous material is uncooked aqueous material.

Preferably, the aqueous material is a liquid aqueous material. Preferably the aqueous material is an oil-in-water emulsion or a water-in-oil emulsion.

In some embodiments, the admixing is in a closeable vessel or system. In other embodiments, the admixing is in an open vessel, or is performed in a closed vessel and the mixture is discharged into an open vessel.

In one embodiment, the admixing is at greater than ambient pressure. In another embodiment, the admixing is at lower than ambient pressure.

In one embodiment, the maintaining of step (5) is at greater than ambient pressure. In another embodiment, the maintaining of step (5) is at lower than ambient pressure. In another embodiment, the maintaining of step (5) is at lower pressure than that at which the admixing of step (4) is performed.

Preferably the admixing is performed at or near the first temperature.

In a further aspect, the invention relates to a method of making a flavour concentrate, the method comprising
(1) heating a lipid material to a first temperature,
(2) adding an aqueous material to the heated lipid material to form a mixture, the aqueous material comprising one or more sugars and one or more proteins, and optionally one or more lipids, the first temperature being above the boiling point of the aqueous material, and
(3) maintaining the heated mixture in a vessel whereupon the majority of the water in the mixture is vapourised, and
(4) heating the mixture to a second temperature that is higher than the first temperature, and
(5) maintaining the mixture at the second temperature for at least about 1 second.

Preferably, the pressure in the vessel in which the material is maintained in step (3) is maintained by extracting the vapour.

In another aspect the invention relates to a method of making a flavour concentrate, the method comprising
(1) heating a lipid material to a first temperature of at least about 100° C.,
(2) adding an aqueous material to the heated lipid material to form a mixture, the aqueous material comprising one or more sugars and one or more proteins, and optionally one or more lipids,
(3) vapourising the majority of the water in the mixture, and
(4) heating the mixture to a second temperature for at least about 1 second, wherein the second temperature is different to the first temperature.

Preferably, the method comprises the additional step
(5) cooling the recovered mixture to a convenient temperature.

In another aspect the invention relates to a method of making a condensed flavour concentrate, the method comprising
(1) heating a lipid material to a first temperature, the lipid material being substantially free of protein or water or both protein and water,
(2) adding an aqueous material to the heated lipid material to form a mixture, the aqueous material comprising one or more sugars and one or more proteins, and optionally one or more lipids, the first temperature being above the boiling point of the aqueous material, wherein at least some of the water present in the aqueous material is vapourised,
(3) extracting the vapour produced in step (2) and
(4) condensing the vapour to form a condensed flavour concentrate.

Preferably, the method comprises the additional step
(5) maintaining the recovered lipid mixture at a convenient temperature.

In one embodiment the method comprises the additional step before step (3) of
(2a) introducing the heated mixture into a vessel whereupon the majority of the water in the mixture is vapourised.

In another aspect the invention relates to a method of making a solids flavour concentrate, the method comprising
(1) providing a lipid material,
(2) providing an aqueous material, the aqueous material comprising one or more sugars and one or more free amine groups,
(3) heating the lipid material to a first temperature at or above the boiling point of the aqueous material,
(4) admixing the heated lipid material and the aqueous material,
(5) maintaining the mixture for a period at a temperature at least until substantially all the water present in the aqueous material is vapourised,
(6) separating the solids from the mixture to form the solids flavour concentrate.

In one embodiment, the method additionally comprises after step (5) one or more of the following optional steps:
5a) maintaining the mixture for a second period at a second temperature that is different to the first temperature,
5b) cooling the mixture.

In another aspect the invention relates to a flavour concentrates produced by a method of the invention.

Preferably, the flavour concentrates comprises one or more flavour characteristics selected from toffee flavour, butterscotch flavour, baked biscuit flavour, caramel flavour, and malt flavour, flavours associated with roasted nuts, heated/roasted popcorn, fried potato chips, baked unleavened breads, flavours associated with roasted meat, blue cheese or cooked pizza.

In another aspect the invention relates to a flavour concentrate comprising, consisting essentially of or consisting of a cooked mixture of a lipid material and an aqueous material, wherein
the lipid material is selected from one or more dairy fats, one or more dairy oils, one or more animal fats, one or more animal oils, one or more vegetable fats, or one or more vegetable oils, and any combination thereof,
the aqueous material comprises one or more sugars and one or more free amine groups, and optionally one or more lipids, and
the composition comprises at least one of the compounds selected from the group consisting of
   1-100 μg/g furfural,
   0.1-10 μg/g 3,4-dihydroxyhex-3-ene-2,5-dione [DHHD]
   5-100 μg/g maltol,
   0.1-10 μg/g furaneol,
   2-30 μg/g acetol,
   1-5 μg/g pentan-2-one,
   1-80 μg/g heptan-2-one,
   0.5-100 μg/g 3-methylbutanal, or
   0-10 μg/g 2-methylbutanal.

In various embodiments, the composition comprises two or more, three or more, four or more, five or more, six or more, seven or more, eight or more, or all nine of the above compounds.

In one example, the composition comprises

1-100 μg/g furfural, and

0.1-10 μg/g 3,4-dihydroxyhex-3-ene-2,5-dione [DHHD].

In another example, the composition comprises

1-100 μg/g furfural and

5-100 μg/g maltol.

In another example, the composition comprises

5-100 μg/g maltol,

0.1-10 μg/g furaneol, and

0.5-100 μg/g 3-methylbutanal.

As will be appreciated, each of the 9! possible permutations or combinations of the above compounds are expressly contemplated as if individually set forth herein.

Any of the embodiments described herein may relate to any of the above aspects.

In various embodiments the lipid material is substantially free of protein or water or both protein and water. In one embodiment the lipid material is substantially anhydrous. In one embodiment the lipid material comprises one or more fats or one or more oils or combinations thereof. In one embodiment the lipid material is selected from one or more dairy fats including milk fat, one or more animal fats, one or more vegetable fats, or any combination thereof. In one embodiment the lipid material comprises at least about 80% to at least about 99% triglycerides, for example at least about 85, 90, 91, 92, 93, 94, 95, 96, 97, 98 or at least about 99% triglycerides, and useful ranges may be selected between any of these forgoing values (for example, about 85% to about 99%, about 90% to about 99%, about 91% to about 99%, about 92% to about 99%, about 93% to about 99%, about 94% to about 99%, about 95% to about 99%, about 96% to about 99%, about 97% to about 99%, and from about 82% to about 92% triglycerides). In one embodiment the lipid material is substantially free of protein. In one embodiment the lipid material is substantially anhydrous. Preferably the lipid material is sourced from any one or more of anhydrous milk fat, butter oil, tallow, lard, or vegetable oils. Suitable vegetable oils include oils derived from almond, amaranth, apricot, artichoke, babassu, ben, borneo tallow nut, bottle gourd, borage seed, buffalo gourd, canola, carob pod, cashew, cocoa, coconut, corn, cottonseed, evening primrose, flaxseed, grape seed, hazelnut, hemp, kapok seed, mustard, olive, palm, peanut, pine nut, poppy seed, pumpkin seed, safflower, sesame, soybean, sunflower, walnut, wheat germ oils, rice bran, legumes and avocado. In one embodiment the lipid material is sourced from a marine oil, for example a marine oil selected from shellfish oils, fish oils, and combinations thereof. In one embodiment the fish oil is selected from anchovy, baikal, bloater, cacha, carp, eel, eulachon, herring, Hoki (Macruronus novaezelandiae), hilsa, jack fish, katla, kipper, mackerel, orange roughy, pangas, pilchard, black cod, salmon, sardine, shark, sprat, trout, tuna, whitebait, and swordfish oils, and combinations of any two or more thereof. In one embodiment the oil is a winterised oil.

Suitable sources of lipids can be obtained from plant, animal and dairy sources, including but not limited to, seeds and grains, animal tissues, dairy, cream and whey sources. Such sources of lipid materials may be modified or refined for edible use by a variety of means known in the art of fats and oils processing, including centrifugal separation and decanting, solvent extraction, chemical modification e.g. catalytic treatment with hydrogen, fractionation on the basis of melting point and distillation. Lipid fractions with a high melting point are often known as hard fractions and low melting point fractions are known as soft fractions. Intermediate fractions are also known. Fats and oils prepared by blending selected lipid stocks and fractions are also known and are useful for the practise of this invention. The aqueous material comprises one or more sugars and one or more free amine groups. In one embodiment the aqueous material is selected or derived from soy bean milk, soy bean protein, or from a reconstituted, recombined, fermented or fresh dairy material e.g. recombined or fresh whole milk, recombined or fresh skim milk, reconstituted whole milk powder, reconstituted skim milk powder, skim milk concentrate, skim milk retentate, concentrated milk, cultured milk, yoghurt, kefir, ultrafiltered milk retentate, milk protein concentrate (MPC), milk protein isolate (MPI), calcium depleted milk protein concentrate (MPC), low fat milk, low fat milk protein concentrate (MPC), casein, caseinate, cream, cultured cream, butter milk, butter serum, a dairy fermentate, whey, whey cream, whey protein concentrate (WPC), or cultured whey cream. In one embodiment, the amine content, or the sugar content, or both the amine content and the sugar content, of the aqueous material may be augmented, for example by the addition of compounds or sources of compounds with one or more amine groups, or one or more sugars, or both.

In one embodiment the aqueous material is selected from legume, cereal, seed, nut, fruit, or vegetable extracts, recombined or fresh whole milk, recombined or fresh skim milk, reconstituted whole milk powder, reconstituted skim milk powder, cultured milk, yoghurt, kefir, milk fat, cream, whey cream, cultured cream, and combinations thereof. In one embodiment the aqueous material is a cultured material such as a cultured milk or cultured cream. Preferably the culture source is a fermentate produced using acid producing bacteria e.g. a yoghurt. More preferably the culture consists of one or more, two or more, or three or more cultures. Other fermentations may use organisms such as yeasts or moulds and other bacteria. Other animal- or micro-organism-derived aqueous materials are also contemplated.

Preferably, when the aqueous material is a cultured material, for example a cultured cream, the aqueous material comprises at least about 10% (w/w) lipid, preferably the aqueous material comprises from at least about 10% (w/w) to about 80% (w/w) lipid, more preferably the aqueous material comprises from at least about 10% (w/w) to about 80% (w/w) lipid, for example at least about 15, 20, 25, 30, 35, 40, 42, 44, 46, 48 or at least about 50% (w/w) lipid, and useful ranges may be selected between any of these forgoing values (for example, from about 22% to about 42% (w/w) lipid.

In various embodiments the methods of the present invention produce a milkfat concentrate having flavour characteristics selected from any one or more of toffee flavour, butterscotch flavour, baked biscuit flavour, caramel flavour, and malt flavour, flavours associated with roasted nuts, heated/roasted popcorn, fried potato chips, baked unleavened breads, flavours associated with roasted meat or cooked pizza.

In one embodiment the method produces a concentrate having a desired flavour chemical profile, more preferably a chemical profile as described herein, for example with reference to Table 1.

In one embodiment the aqueous material is an uncooked aqueous material.

In one embodiment the first temperature is above the boiling point of the aqueous material—i.e., the boiling point of the aqueous material at the pressure at which the admixing is performed. In one embodiment the lipid material is heated to a first temperature of at least about 100 to about 180 degrees Celsius, for example at least about 100, 105, 110, 115, 120, 125, 130, 135, 140, 145, 150, 155, 160, 165, 170, 175 or about 180 degrees Celsius and useful ranges may be selected between any of these forgoing values (for example, from about 100 to about 140, about 100 to about 160 or about 100 to about 170 degrees Celsius). Preferably the lipid material is heated to 110-145° C. and more preferably approximately 135° C.

In some embodiments, the admixing is performed at a rate, for example at a rate of addition of aqueous material to lipid material such that the majority of the moisture in the mixture is vapourised during admixing. For example, the rate of admixing or the ratio of lipid material to aqueous material is adjusted according to the first temperature, and optionally the temperature of the aqueous material. In other embodiments, the vapourisation of substantially all of the moisture is additionally achieved during the maintaining step following admixing.

In one embodiment the mixture is maintained at or about the first temperature at least until substantially all the water is vapourised. In another embodiment the mixture is maintained at another temperature at least until substantially all the water is vapourised.

In one embodiment, when the mixture is maintained at another temperature at least until substantially all the water is vapourised, the temperature is at least about 100 to about 180 degrees Celsius, for example at least about 100, 105, 110, 115, 120, 125, 130, 135, 140, 145, 150, 155, 160, 165, 170, 175 or about 180 degrees Celsius and useful ranges may be selected between any of these forgoing values (for example, from about 100 to about 140, about 100 to about 160 or about 100 to about 170 degrees Celsius).

In one embodiment, when the mixture is maintained at or about the first temperature or at another temperature, the mixture is maintained at a lower pressure than the pressure at which the admixing is performed. For example, the mixture is discharged into a vessel maintained at lower pressure than the pressure at which admixing is performed.

In one embodiment, the mixture is maintained at or about the first temperature or at another temperature for at least about 1 minute, about 2 minutes, about 3, 4, 5, 6, 7, 8, 9, 10, 11, 12, 13, 14, 15 16 17 18 19, 20, 25, 30, 35, 40, 45, 50, 55, or 60 minutes, and useful ranges may be selected between any of these forgoing values (for example, about 1 to about 20 minutes, about 1 to about 30 minutes, about 1 to about 40 minutes, about 1 to about 50 minutes, and about 1 to about 60 minutes).

In one embodiment, the mixture is maintained at or about the first temperature or at another temperature for about 1, 2, 3, 4, 5, 6, 7, 8, 9, 10, 11, 12, 13, 14, 15, 16, 17, 18, 19, 20, 25, 30, 35, 40, 45, 50, 55, or 60 minutes after substantially all the water is vapourised, and useful ranges may be selected between any of these forgoing values (for example, about 1 to about 20 minutes, about 1 to about 30 minutes, about 1 to about 40 minutes, about 1 to about 50 minutes, and about 1 to about 60 minutes).

In other embodiments, when substantially all the water is vapourised, the mixture is maintained at a second temperature. In one embodiment, the second temperature is lower that the first temperature, or lower than the temperature at which the mixture is maintained at least until substantially all the water is vapourised. Preferably the second temperature is higher than the first temperature. Preferably the second temperature is higher than the temperature at which the mixture is maintained at least until substantially all the water is vapourised.

In one embodiment the second temperature is at least about 105, 110, 115, 120, 125, 130, 135, 140, 145, 150, 155 or 160 degrees Celsius, and useful ranges may be selected between any of these forgoing values. Preferably the second temperature is about 120-140° C., more preferably about 130 to 140° C., and more preferably about 135° C.

In one embodiment, the mixture is maintained at the second temperature for at least about 1 second, about 10 seconds, 20, about 30 seconds, about 1 minute, about 2, 3, 4, 5, 6, 7, 8, 9, 10, 11, 12, 13, 14, 15, 16, 17, 18, 19, 20, 25, 30, 35, 40, 45, 50, 55, or 60 minutes, and useful ranges may be selected between any of these forgoing values (for example, about 1 to about 20 minutes, about 1 to about 30 minutes, about 1 to about 40 minutes, about 1 to about 50 minutes, and about 1 to about 60 minutes).

In one embodiment, the mixture is heated at the second temperature for about 10 to 20 minutes, and more preferably for about 12 to 15 minutes.

In other embodiments, such as those where the first or second temperature is lower, for example about 105 to 115° C., the mixture is heated for about 15, 20, 25, 30, 35, 40, 45, 50, 55, or 60 minutes, and useful ranges may be selected between any of these forgoing values.

In one embodiment the method further comprises a step to remove solid matter from the heat treated mixture. Any convenient device may be used. Preferably a separation step, such as a filtration step or a clarifying step or both, is included after mixing or after heating of the mixture. Devices suitable for use in such a separation step, such as centrifuges, decanters or membrane filters, are well known in the art and are contemplated for use in the methods of the present invention.

In another aspect the invention relates to a composition formed from any of the methods described above. Expressly contemplated are concentrates formed by the condensation of vapour produced by the admixture of the lipid material and the aqueous material, or the admixture of an aqueous material and the mixture, or by the subsequent vapourisation or heating of these mixtures. Also expressly contemplated are solids flavour concentrates formed by the admixture of the lipid material and the aqueous material, or the admixture of an aqueous material and the mixture, or by the subsequent heating of these mixtures as described herein.

In another aspect the invention relates to use of one or more of the compositions described above as a flavouring agent in a food. In another aspect the invention relates to a food comprising a flavour concentrate described above.

Expressly contemplated is the use of one or more of the flavour concentrates or compositions comprising one or more flavour concentrates as described herein as a flavouring agent in chocolate or confectionery. In another embodiment, the invention relates to chocolate or confectionery comprising a flavour concentrate described above. For example, in one specifically contemplated embodiment, the invention relates to chocolate or confectionery comprising a flavour concentrate, a condensed flavour concentrate, a solids flavour concentrate, as described herein, or any combination of two or more of these flavour concentrates.

In another embodiment, the invention relates to the use of a flavour concentrate as described herein, for example the lipid flavour concentrate, in a nougat. In one embodiment, the nougat comprises part of a confectionery bar, while in another embodiment the nougat is an individual confectionery. In a related specifically contemplated embodiment, a flavour concentrate, a condensed flavour concentrate, a solids flavour concentrate, as described herein, or any combination of two or more of these flavour concentrates can be added to other components (including, for example caramel) comprising a multi-component confectionery bar, a single component confectionery or a multi-component confectionery.

Other aspects of the invention may become apparent from the following description which is given by way of example only.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7). It will therefore be apparent that specified numeric ranges denote parameters spanning continuous regions of applicability for the practice of the invention.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

### BRIEF DESCRIPTION OF THE DRAWINGS

FIG. 1 shows a schematic flow diagram of the method of the present invention.

FIG. 2 shows a schematic diagram of an exemplary production method of the invention using batch processing. The vessel (1) is heated and the contents are stirred using an agitator (2). A quantity of lipid material (3) is placed in the vessel and stirred and heated to a first temperature, preferably above 100° C. When this temperature is reached, aqueous material, for example cream, is introduced through inlet (4) using a positive pump. The water-soluble volatiles that are evaporated with the steam exit through aperture (5). The rate of boil-off from the vessel may be assisted by application of a vacuum to aperture (5), and the volatiles may be collected by condensing the distillate. When all the aqueous material has been added to the vessel, the heating is continued until there is minimal evidence of steam. The vessel contents are then cooled by introduction of water into the vessel jacket (7) to a temperature (preferably 45-60° C.) that allows the mixture to be handled through standard pumps and filters. The contents are then removed from the vessel via a product outlet (6).

FIG. 3 shows a schematic diagram of an exemplary production method of the invention using batch processing with an external heater. The vessel (1) holds lipid material (for example, AMF) (2) that is heated by external circulation using pump (3) through heat exchangers (9) to a temperature of 100° C.-170° C. At that temperature, aqueous material (for example, cream) (6a) is introduced into the circuit after the heat exchangers via pump (7a) and valve (4a) positioned close to a back-pressure valve (5) set to give a pressure between 100 and 600 kPa. Alternatively the aqueous material (6b) may be introduced before the external heat exchangers via pump (7b) and valve (4b). In this alternative the back-pressure valve (5) remains in place and is set to the same pressure range as before. The product may be removed for downstream applications, cooling or packaging as required through the product outlet (8), or returned for further processing via the product circulation return (10). Volatiles may be removed via a volatiles outlet (11), these can either be condensed for use or to be discarded. Service heating and cooling (steam or water) exits via service outlet (14). The heat source introduced into the heat exchanger at the heat inlet (13) will typically be steam, but will depend on the plant setup. A plant drain (12) is provided for convenience, for example for cleaning and maintenance.

FIG. 4 shows a schematic diagram of an exemplary production method of the invention, again using batch processing with an external heater. The vessel (1) holds lipid material (2) that is heated by external circulation using pump (3) through heat exchangers (9) to a temperature of about 135° C. Aqueous material (6) is heated in a heater (17) and introduced into the circuit after the heat exchangers via pump (7) and valve (4a) positioned close to a back-pressure valve (5) set to give a pressure between 200 and 300 kPa. Alternatively the aqueous material may be introduced before the external heat exchangers via valve (4b). The product may be removed for downstream applications, cooling or packaging as required through the product outlet (8), or returned for further processing via the product circulation return (10). Volatiles may be removed via a volatiles outlet (11), while condensates may be recovered using a condenser (20) to yield a condensed flavour concentrate (21) or may be discarded. Service heating (in this case water) exits via service outlet (14) and is usefully recycled. In this embodiment, the heat source introduced into the heat exchanger is high pressure heated water (22) heated in a high pressure water heater (23) through the introduction of steam (13). A plant drain (12) is also provided, particularly for convenience of for example, cleaning and maintenance.

FIG. 5 shows mean flavour intensities for milk chocolate with either Standard WMP, caramelised WMP (confectionary WMP) or 2% exemplary flavour composition 300 addition in place of caramelised WMP.

FIG. 6 shows MDS dimensions 1 and 2 for milk chocolate samples with vectors from attribute ratings showing significant milk chocolate differentiation projected into the MDS space.

FIG. 7 shows trained panel descriptive analysis of exemplary flavour composition 300-AMF mixtures (n=8).

FIG. 8 shows consumer sensory profiles of milk chocolate samples (full scale 0-150, n=42).

FIG. 9 shows consumer perception of caramel flavour in Brand A, and in Brand A with the addition of exemplary flavour concentrates of the invention (n=42).

FIG. 10 shows consumer perception of bitterness in Brand A, and in Brand A with the addition of exemplary flavour concentrates of the invention (n=42).

FIG. 11 shows a sample of a Consumer Questionnaire.

### DETAILED DESCRIPTION OF THE INVENTION

### 1. Definitions

The term “comprising” as used in this specification means “consisting at least in part of”. When interpreting statements in this specification which include that term, the features, prefaced by that term in each statement, all need to be present but other features can also be present. Related terms such as “comprise” and “comprised” are to be interpreted in the same manner.

As used herein the term “aqueous material” means any material with moisture content above 10%.

As used herein the term “uncooked aqueous material” includes any material that is pasteurised or has undergone ultra-heat treatment (UHT) but is otherwise not heat treated for the purpose of generating flavours.

It should be apparent that for the purposes of the present invention, uncooked aqueous material may be heated immediately prior to admixture without being considered cooked.

As used herein the terms “lipid”, “fat” and “oil” and respective plurals thereof are essentially interchangeable and refer to edible substances composed largely (greater than about 80%) of triglycerides selected or derived from any one or more of vegetable, animal, or dairy sources, or combinations thereof.

“Ghee” denotes a traditional product derived from milk used extensively across the Middle East and the Indian sub-continent since ancient times and is prepared historically by heating milk fat, butter or cream in a vessel over an open fire. Ghee is an international commodity with a label of identity given by CODEX STAN A-2-1973 (amended 2006) available at http://www.codexalimentarius.net/download/standards/171/CXS_A02e.pdf.

The terms “anhydrous milk fat”, “anhydrous butter oil” and “butter oil” are used interchangeably herein and refer to the milk fat fraction produced by phase inversion and concentration of cream, or from melted butter and are also classified under CODEX STAN A-2-1973. Milk fat may be any mammalian milk fat including but not limited to bovine, sheep, goat, pig, mouse, water buffalo, camel, yak, horse, donkey, llama or human milk fat, with bovine milk fat being a preferred source. Methods commonly used for the preparation of AMF are disclosed in Bylund, G. (Ed.) Dairy processing handbook. 1995 Tetra Pak Processing Systems AB, S-221 86 Lund, Sweden.), incorporated herein in its entirety. Fats and oils generally comprise a mixture of triglycerides which may be separated by various known processes, more particularly, by methods relying on their different melting points. Portions with a high melting point are often termed “hard fraction” and the low melting point fraction termed “soft fraction” etc. Intermediate fractions and blends of fractions are known. The chemistry of triglycerides is well known and the associated fatty acids may have zero (unsaturated), one (mono-unsaturated) or multiple (poly unsaturated) “double bonds” in their molecules. A standard nomenclature well known in the art is used to denote the number and location of double bonds in the fatty acid molecules.

As used herein, the term “flavour” contemplates the sensory impression of a food or other substance, and is primarily determined by the senses of taste and smell. Accordingly, the term “flavour” should be considered to includes aroma, smell, odour and the like.

### 2. Method of Producing Flavour Concentrates

Milkfat and vegetable oils are often used in spreads and as condiments, as well as in cooking applications such as baking, sauce making, and frying. As a result, these lipids are consumed daily in many parts of the world.

The present invention is directed towards flavour concentrates, particularly a milkfat concentrate that has excellent flavour characteristics. This allows addition of the milkfat concentrate to food at lower amounts than normal milkfat products, while still imparting the desired flavour characteristics, or alternatively allows enhanced flavour to be imparted when the milkfat concentrate is used in similar amounts as normal milkfat products.

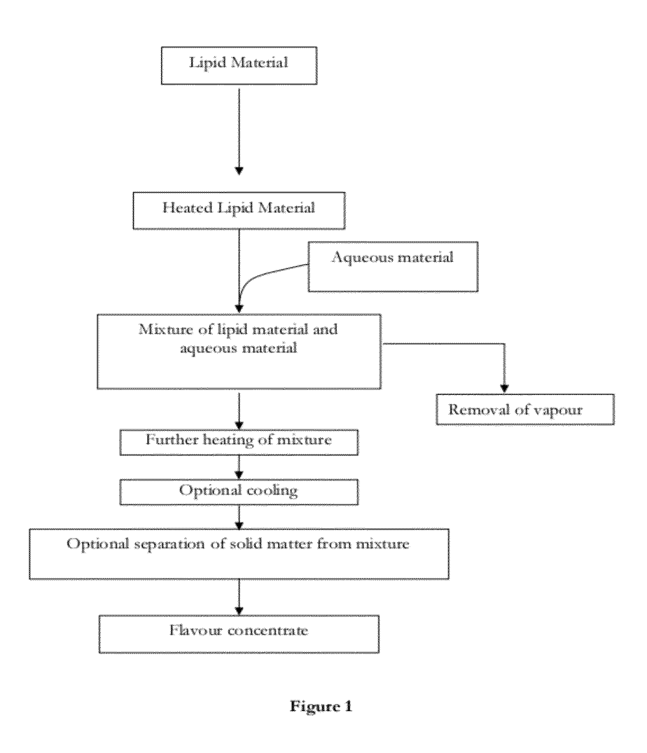

As shown in FIG. 1, the present inventors have found that a flavour concentrate can be produced by the following steps:
(1) providing a lipid material,
(2) providing an aqueous material, the aqueous material comprising one or more sugars and one or more free amine groups,
(3) heating the lipid material to a first temperature at or above the boiling point of the aqueous material,
(4) admixing the heated lipid material and the aqueous material, and
(5) maintaining the mixture for a period at a temperature at least until substantially all the water present in the aqueous material is vapourised.

In one embodiment, the method additionally comprises after step (5) the step:
(6) maintaining the mixture for a second period at a second temperature that is different to the first temperature.

In various embodiments, the temperature at which the mixture is maintained in step (5) is below, at or above the first temperature.

In preferred embodiments, the method additionally comprises after step (5) or preferably after step (6) one or more of the following optional steps:
(7) the mixture is cooled,
(8) the mixture is passed through a separation device to remove solid matter,
(9) the mixture is packaged.

In another aspect, the invention provides a method of making a flavour concentrate comprising the following steps:
(1) heating a lipid material to a first temperature of at least about 100° C.,
(2) adding an aqueous material to the heated lipid material to form a mixture, the aqueous material comprising one or more sugars and one or more proteins, and optionally one or more lipids,
(3) vapourising the majority of the water in the mixture, and
(4) heating the mixture to a second temperature for at least about 1 second, wherein the second temperature is different to the first temperature.

Preferably, the method comprises the additional step
(5) cooling the recovered lipid material to a convenient temperature.

In a preferred embodiment, the method additionally comprises after step (4) or preferably after step (5) one or more of the following optional steps:
(6) the mixture is passed through a separation device to remove solid matter,
(7) the mixture is packaged.

In another aspect, the invention provides a method of making a flavour concentrate, the method comprising the following steps:
(1) heating a lipid material to a first temperature,
(2) adding an aqueous material to the heated lipid material to form a mixture, the aqueous material comprising one or more sugars and one or more proteins, and optionally one or more lipids, the first temperature being above the boiling point of the aqueous material, and
(3) maintaining the heated mixture in a vessel whereupon the majority of the water in the mixture is vapourised, and
(4) heating the mixture to a second temperature that is higher than the first temperature, and
(5) maintaining the mixture at the second temperature for at least about 1 second.

Preferably, between about 1% to 200% (w/w) aqueous material relative to lipid material is added, more preferably about 10% to about 200% (w/w), about 20% to about 150% (w/w), about 20% to about 120% (w/w), about 20% to about 100% (w/w) aqueous material relative to lipid material is added, or about 25% to about 80% (w/w) aqueous material relative to lipid material is added.

It will be appreciated that rate at which the aqueous material and lipid material are admixed will depend on, among other considerations, their relative temperatures, volumes, and the nature of the processing plant used for production of the flavour concentrate. For example, in some embodiments, preferably batch processing embodiments, the aqueous material is added at rate of between about 1% to 200% (w/w) relative to lipid material per hour, more preferably at about 10% to about 200% (w/w), about 20% to about 150% (w/w), about 20% to about 120% (w/w), about 20% to about 100% (w/w), or about 25% to about 80% (w/w) per hour, more preferably at about 100% (w/w) relative to lipid material per hour. In other embodiments, preferably continuous processing embodiments, the aqueous material is added at rate of between about 0.01% to 50% (w/w) relative to circulating lipid material per hour, more preferably at about 0.1% to about 20% (w/w), about 0.1% to about 10% (w/w), or about 0.5% to about 5% (w/w) relative to circulating lipid material per hour.

Preferably, the aqueous material is mixed rapidly with the lipid material, for example in a flow channel or a vessel.

Rapid mixing of the aqueous material with the heated lipid material allows the rapid heating and vapourisation or “flashing off” of the majority of the water present in the aqueous mixture. This rapid removal of water can be augmented by one or more vapourisation steps if desired. In certain embodiments, the vapourisation step may be conducted in the same vessel as the mixing step. In other embodiments, the vapourisation step may be conducted in a flow channel or second vessel, for example by withdrawing the mixture from the flow channel or vessel used in the mixing step. Preferably, this flow channel or second vessel is maintained at a lower pressure than that at which the mixing step is performed.

In one embodiment, vapourisation of the water present in the aqueous material is achieved by maintain the mixture to a temperature that is higher than the boiling point of the aqueous material. In other embodiments, vapourisation of the water present in the aqueous material is achieved by reducing the pressure at which the mixture is maintained, preferably by reducing the pressure at which the mixture is maintained, for example by reducing the pressure in the closeable vessel or system, or by discharging the mixture into an open vessel, or discharging the mixture into a closeable vessel or system maintained at a lower pressure. For example, in one embodiment, the maintaining of step (5) is at lower than ambient pressure. In another embodiment, the maintaining of step (5) is at lower pressure than that at which the admixing of step (4) is performed.

As used herein the phrase “substantially all the water present in the aqueous material is vapourised” contemplates at from at least about 65% to about 100% of the water present in the aqueous material is vapourised, for example at least about 70, 75, 80, 85, 86, 87, 88, 89, 90, 91, 92, 93, 94, 95, 96, 97, 98 or at least about 99% of the water present in the aqueous material is vapourised, and useful ranges may be selected between any of these forgoing values (for example, from about 82% to about 100% of the water is vapourised.

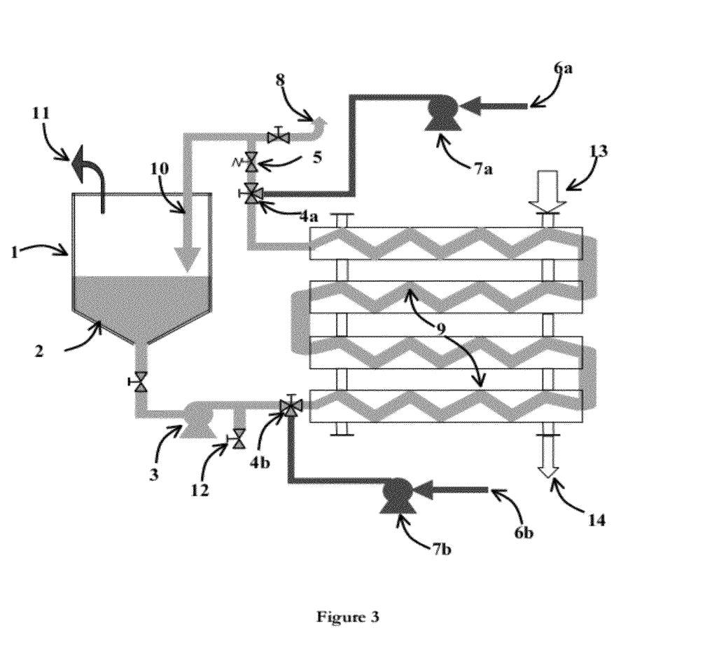

In certain embodiments, it is desirable to remove the vapour, for example to maintain the pressure in the vessel or flow channel. This will depend on the design of the processing plant, and is contemplated in the exemplary plant shown in FIG. 3. Preferably, the pressure in the vessel in which the material is maintained is maintained by extracting the vapour. It will be appreciated that conditions suitable for boiling off the water may be maintained by any one or more of removing the resulting vapour, additional heating of the mixture, or the admission of fresh material.

Preferably, the extracted vapour is condensed to form a flavour concentrate, as described herein.

Once the majority of the water present in the mixture has been removed, the mixture, now with a lower moisture content than that of the aqueous material prior to addition, may be maintained at or about the first temperature, or another temperature, and/or may be maintained at a second temperature (for example, the mixture is subjected to a second heating step).

It will be appreciated that the duration of the maintaining step (s) may vary, and may depend on for example the first temperature, the temperature of the aqueous material, the pressure at which admixing and/or maintaining is performed, the ratio of aqueous material to lipid material, the rate of admixing, the composition of the lipid material, the composition of the aqueous material, or the desired flavour characteristics of the flavour concentrate.

In various embodiments, the second temperature is higher than the first temperature. However, temperatures lower than the first temperature are contemplated, and may be selected depending on, for example, the starting materials, the flavours to be developed, the capabilities of the processing plant, to improve process control, or the downstream use(s) to which the flavour concentrate will be put.

Preferably the admixing and maintaining is conducted with a view to removing sufficient water from the aqueous material so that when the resulting particles of milk solids-not-fat are heated, for example by coming into contact with a heat exchange surface, they do not stick and foul the plant.

The methods of the invention enable the control of the browning reaction(s) such that the flavour and aroma profiles and their intensity can by controlled to give final products with a range of flavour and aroma profiles as required.

In certain embodiments, after the final maintaining step the mixture may be cooled to a convenient temperature for processing, such as the separation of any solids from the liquid mixture, or for downstream processing, such as the packaging of the mixture.

In one embodiment, the lipid material is heated to an elevated temperature and mixed with the aqueous material in a flow channel. The mixture may then be discharged into a vessel, preferably heated and/or maintained at a lower pressure, so that rapid boiling occurs. In other embodiments, the aqueous material, which is optionally preheated, may be directly added into the vessel to contact the heated lipid material residing therein.

In various embodiments the aqueous material may be preheated to a temperature close to its boiling point prior to mixing with the heated lipid material. It will be appreciated that this may be done so as to minimise the drop in the temperature of the lipid material on addition of the aqueous material, and/or to improve processing, for example to ease addition of the aqueous material.

It should be appreciated that any lipid material with a sufficiently high lipid content could be used. Preferably the lipid material comprises about 90, 91, 92, 93, 94, 95, 96, 97, 98, 99 or 100% lipid. Examples of suitable lipid material include any vegetable, animal or dairy sourced lipids. Additionally, the lipid material may comprise one or more edible fats or one or more edible oils or combinations thereof.

In one embodiment of the present invention the lipid material is substantially anhydrous. Preferably the lipid material has a water content of less than about 5, 4, 3, 2 or 1%. More preferably the lipid material has a water content of less than about 2%.

Without wishing to be limited by theory, the flavour characteristics are highly dependent on the materials used and the heating characteristics. As discussed above, preferably the starting material is a lipid material to which is added an aqueous material. To ensure that unwanted flavour characteristics, for example burnt flavours, are not produced the heating process needs to be well-controlled; this can be achieved where the lipid material is heated to a temperature above the boiling point of the aqueous material, yet below that which would generate unwanted flavours. In addition, burn-on on the heat transfer surfaces should be avoided to avoid unwanted flavours. More specifically, the applicants have found that the rapid admixing of the lipid material and the aqueous material and the vapourisation of the majority of the water allows desirable flavour components to form and be retained in the mixture and other components are either not formed or can be be removed with the water vapour. Furthermore, the applicants have determined that condensed flavour concentrates derived from this vapour can be recovered that have desirable flavour characteristics suitable for use in various applications.

In one embodiment of the present invention the lipid material is heated to a first temperature of at least about 100 to about 180 degrees Celsius, for example at least about, 100, 105, 110, 115, 120, 125, 130, 135, 140, 145, 150, 155, 160, 165, 170, 175 or about 180 degrees Celsius and useful ranges may be selected between any of these forgoing values (for example, from about 100 to about 160 or about 100 to about 170 degrees Celsius). Preferably the first temperature is at least about 110 to about 140° C. and more preferably approximately 135° C. It should be appreciated that an important consideration is that the first temperature is above the boiling point of the aqueous material.

Once the lipid material and aqueous material are combined and mixed, the mixture is allowed to boil (for example in a flash vessel) at least until substantially all the remaining water is vapourised, the remaining substantially dehydrated mixture is maintained at or about the first temperature, or at another temperature, or may additionally be maintained at a second temperature that is different to the first temperature. It is believed, without wishing to be bound by any theory, that this maintaining of the mixture is important to continue flavour-generating reactions.

In one embodiment of the present invention the remaining substantially dehydrated mixture is heated to a temperature above that to which the lipid material was heated.

In one embodiment of the present invention the second temperature is at least about 100, 105, 110, 115, 120, 125, 130, 135, 140, 145, 150, 155, 160, 165, or about 170° C. Preferably the second temperature is at least about 120 to about 160° C., more preferably about 130 to 140° C., and more preferably about 135° C.

In various embodiments the mixture is held for at least about 1 second, about 10 seconds, 20, 30, 40, or 50 seconds, about 1, 2, 3, 4, 5, 6, 7, 8, 9, 10, 11, 12, 13, 14, 15, 16, 17, 18, 19, 20, 25, 30, 35, 40, 45, 50, 55, or 60 minutes. Preferably the mixture is heated for 2 to 10 minutes, and more preferably for about 2 to 5 minutes, or for about 2 to 4 minutes.

In other embodiments, such as those where the first temperature or the second temperature is lower, for example about 105 to 115° C., the mixture is heated for about 15, 20, 25, 30, 35, 40, 45, 50, 55, or 60 minutes.

It will be appreciated that the time for which the mixture is heated is at least in part temperature dependent. For example, the mixture may be heated at higher temperatures for shorter periods, and vice versa, while still achieving the development of desirable flavour characteristics. For example, where the temperature is lower, for example about 105 to 115° C., the mixture may be heated for longer periods, such as about 15, 20, 25, 30, 35, 40, 45, 50, 55, or 60 minutes. Conversely, when the temperature is higher, for example about 130 to 150° C., the period may be shorter, such as about 2 to 4 minutes.

In a further embodiment of the present invention the method of producing a milkfat concentrate includes a solids removal step after mixing and heating of the lipid material and aqueous material.

Suitable sources of lipids can be obtained from plant, animal and dairy sources, including but not limited to, seeds and grains, animal tissues, dairy, cream and whey sources. Such sources of lipid materials may be modified or refined for edible use by a variety of means known in the art of fats and oils processing, including centrifugal separation and decanting, solvent extraction, chemical modification e.g. catalytic treatment with hydrogen, fractionation on the basis of melting point and distillation. Lipid fractions with a high melting point are often known as hard fractions and low melting point fractions are known as soft fractions. Intermediate fractions are also known. Fats and oils prepared by blending selected lipid stocks and fractions are also known and are useful for the practise of this invention. Preferably the lipid material is selected from any one or more of a dairy sourced lipid, such as anhydrous milk fat or butter oil, or tallow, lard or other animal fat.

Modified, refined, fractionated, derivatised or otherwise processed lipid materials such as those exemplified above or produced by the methods exemplified above are collectively referred to herein as “modified” lipid materials. For example, a fractionated dairy fat may be conveniently referred to as a “modified dairy fat”.

The dairy sourced lipid is preferably selected or extracted from any cultured or uncultured recombined, powdered or fresh skim milk, reconstituted whole or concentrated milk, ultrafiltered milk retentate, milk protein concentrate (MPC), milk protein isolate (MPI), milk fat, cream, butter, anhydrous milk fat (AMF), butter milk, butter serum, hard milk fat fractions, soft milk fat fractions, extracts of any of these milk derivatives including extracts prepared by multistage fractionation, differential crystallisation, solvent fractionation, supercritical fractionation, near supercritical fractionation, distillation, centrifugal fractionation, or fractionation with a modifier (e.g. soaps or emulsifiers), hydrolysates of any of these derivatives, fractions of the hydrolysates, and combinations of these derivatives, including combinations of hydrolysed and/or non-hydrolysed fractions.

In one embodiment the aqueous material is selected or derived from soy bean milk, soy bean protein, from a reconstituted, recombined, fermented or fresh dairy source (also referred to herein as a dairy material) e.g. whole milk, recombined or fresh skim milk, reconstituted whole milk powder, reconstituted skim milk powder, skim milk concentrate, skim milk retentate, concentrated milk, cultured milk, yoghurt, kefir, ultrafiltered milk retentate, milk protein concentrate (MPC), milk protein isolate (MPI), calcium depleted milk protein concentrate (MPC), low fat milk, low fat milk protein concentrate (MPC), casein, caseinate, cream, cultured cream, butter milk, butter serum, a dairy fermentate, whey, whey protein concentrate (WPC), whey cream, or cultured whey cream.

In one embodiment the aqueous material is selected from legume, cereal, seed, nut, fruit, or vegetable extracts, recombined or fresh whole milk, recombined or fresh skim milk, reconstituted whole milk powder, reconstituted skim milk powder, cultured milk, yoghurt, kefir, milk fat, cream, whey cream, cultured cream, and combinations thereof. In one embodiment the aqueous material is a cultured material such as a cultured milk or cultured cream. Preferably the culture source is a fermentate produced using acid producing bacteria e.g. a yoghurt. More preferably the culture consists of one or more, two or more, or three or more cultures. Other fermentations may use organisms such as yeasts or moulds or other bacteria. Other animal- or micro-organism-derived aqueous materials are also contemplated.

Preferably the aqueous material is selected from any one or more of cream, whey cream, or cultured cream.

Preferably, the aqueous material is an uncooked aqueous material as defined herein.

The applicants have determined that the vapour produced on mixing of the aqueous material and the lipid material comprises volatile compounds in addition to water, and that condensed flavour concentrates recovered from this vapour may also have desired flavour characteristics. Expressly contemplated are concentrates formed by the condensation of vapour produced by the admixture of the lipid material and the aqueous material, or the admixture of an aqueous material and the lipid material/aqueous material mixture, or by the subsequent vapourisation or heating of these mixtures.

Accordingly, in another aspect the invention relates to a method of making a flavour concentrate, the method comprising
(1) heating a lipid material to a first temperature, the lipid material being substantially free of protein or water or both protein and water,
(2) adding an aqueous material to the heated lipid material to form a mixture, the aqueous material comprising one or more sugars and one or more proteins, and optionally one or more lipids, the first temperature being above the boiling point of the aqueous material, wherein at least some of the water present in the aqueous material is vapourised,
(3) extracting the vapour produced in step (2) and
(4) condensing the vapour to form a flavour concentrate.

Preferably, the method comprises the additional step
(5) maintaining the recovered lipid mixture at a convenient temperature.

In one embodiment the method comprises the additional step before step (3) of
(2a) introducing the heated mixture into a vessel whereupon the majority of the water in the mixture is vapourised.

The applicants have further determined that the solids produced on mixing of the aqueous material and the lipid material and maintenance of the mixture at elevated temperature comprise useful compounds and that flavour concentrates from these solids may also have desired flavour characteristics. Expressly contemplated are concentrates formed by the separation of the solids from the liquid mixture.

Accordingly, in another aspect the invention relates to a method of making a solids flavour concentrate, the method comprising
(1) providing a lipid material,
(2) providing an aqueous material, the aqueous material comprising one or more sugars and one or more free amine groups,
(3) heating the lipid material to a first temperature at or above the boiling point of the aqueous material,
(4) admixing the heated lipid material and the aqueous material,
(5) maintaining the mixture for a period at a temperature at least until substantially all the water present in the aqueous material is vapourised,
(6) separating the solids from the mixture to form the solids flavour concentrate.

In one embodiment, the method additionally comprises after step (5) one or more of the following optional steps:
5c) maintaining the mixture for a second period at a second temperature that is similar or different to the first temperature,
5d) cooling the mixture.

Methods and devices for the separation of solids from liquids are well known in the art, and any convenient device may be used. The separation step may, for example, be a filtration step or a clarifying step or both. Devices suitable for use in such a separation step, such as centrifuges, decanters or membrane filters, are well known in the art and are contemplated for use in the methods of the present invention. In some embodiments, it will be convenient to cool the mixture prior to the separation of the solids from the liquid mixture.

As will be appreciated by those skilled in the art, the methods of the invention may be conveniently conducted on a continuous basis, or a batch basis. Either methodology allows the admixing of aqueous material with the lipid material, or indeed the iterative admixing of aqueous material with the lipid material or the mixture resulting from a previous mixing step. As exemplified herein, the aqueous material added in a subsequent mixing step may differ to that added in a previous mixing step.

Those skilled in the art will further appreciate that the methods of the present invention are particularly amenable to production at commercial scale, for example using modern dairy products processing techniques and equipment. Exemplary plant designs used in the commercial-scale manufacture of flavour concentrates of the present invention are described herein. Efficient commercial production, such as continuous batch processing with no or little downtime (for example, as required for washing plant such as, for example, heat exchanger surfaces), can be achieved using the methods of the present invention.

It will be appreciated that the design of a given plant and the processes to be implemented therein are interrelated, and so many plant designs may be suitable for implementing various embodiments of the present invention. The applicants have, however, determined that the avoidance of fouling and particularly burn-on (particularly on heat-exchanger surfaces) is a key design criterion for any such plant so as to achieve continuous production with little or no downtime. For example, in one implementation of a trial plant, the use of shallower temperature gradient across the heat exchanger (such as may be achieved using high pressure heated water rather than steam) has been found by the applicants to result in no or little detectable burn-on. In another implementation, the use of a conical reaction vessel enabled continuous batch processing to be implemented without the need for cleaning between batches.

2.1 Exemplary Preparation of Flavour Concentrates in a Batch Operation with Internal Heating

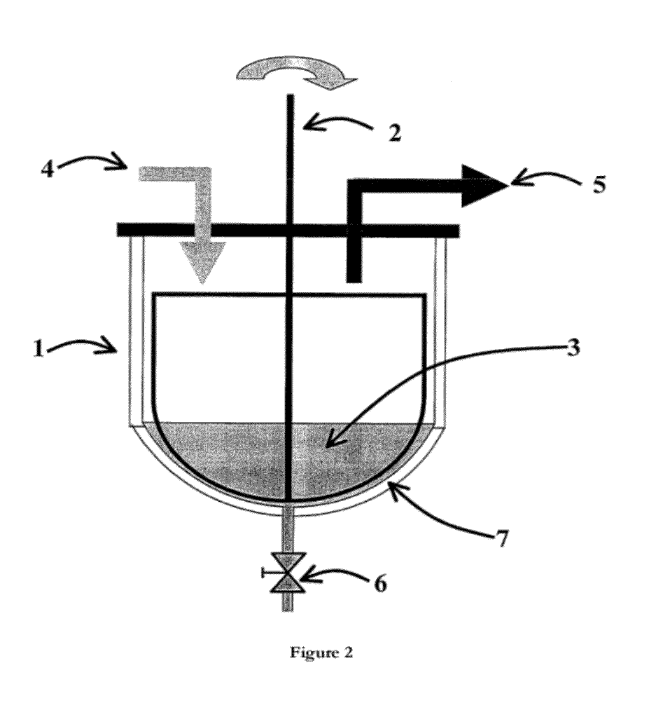

An exemplary batch process for manufacture of a flavour concentrate using the method of this invention is described below. A schematic view of this process is shown in FIG. 2. The vessel (1) is heated with steam and the contents may be stirred using an agitator (2) (fitted with Teflon® scraper blades). A quantity of lipid material (3) is placed in the vessel and stirred and heated to a first temperature, preferably above 100° C. When this temperature is reached, aqueous material, for example cream, is introduced through inlet (4) using a positive pump. The rate of addition may be determined by the rate of evaporation of the aqueous phase of the aqueous material, which in turn is determined by the temperature of the contents of the vessel. During the process, the protein and other non-fat solids (SNF) (such as non-fat-milk solids (MSNF)) undergo Maillard browning reactions.

The volatiles that are evaporated with the steam exit though aperture (5). The rate of boil-off from the vessel may be assisted by application of a vacuum to aperture (5), and the water-soluble volatiles may be collected by condensing the distillate.

When all the aqueous material has been added to the vessel, the heating is continued until no more steam is given off and further Maillard browning reactions occur.

The vessel contents are then cooled by introduction of water into the vessel jacket (7) to a temperature (preferably 45-60° C.) that allows the mixture to be handled through standard pumps and filters.

The contents are then removed from the vessel via a product outlet (6). The browned solids may be separated from the flavoured fat using any of a number of standard separation techniques, including filtration through a plate and frame filter press, separation through a centrifugal separator, and separation in a decanter separator. The resultant fat product and curd residue may then be packed.

2.2 Exemplary Preparation of Flavour Concentrates in a Batch Operation with an External Heating Circuit

Another method of performing at least one aspect of the invention is described below with reference to FIG. 3.

FIG. 3 shows the process with an external heating circuit applied. In most situations, this will be the preferred process. The vessel (1) holds the lipid material (2) that is heated by external circulation using pump (3) through heat exchangers (9) to a temperature above the boiling point of the aqueous material under applied pressure. The steam inlet (13) and the condensate drain (14) are shown on the heat exchanger. At that temperature, the aqueous material (6a) is introduced into the circuit after the heat exchangers via pump (7a) and valve (4a) positioned close to back-pressure valve (5) set to give a pressure between 100 and 600 kPa (kilopascals). Alternatively, the aqueous material (for example, cream) (6b) may be introduced before the external heat exchangers via pump (7b) and valve (4b). In this alternative the back-pressure valve (5) remains in place and is set to the same pressure range as before.

In the heat exchangers, the lipid material or mixture of lipid and aqueous materials is superheated. The milk solids-not-fat undergoes Maillard browning reactions and, on re-entering the reaction vessel via a product circulation return (10), the superheated water is converted immediately to steam.

Steam and other volatiles are flashed off and exit via an outlet (11). As described above, the steam and other condensables may be extracted (for example by using a partial vacuum), condensed and collected.

Once all the aqueous material is added, the heating is continued until there is minimal evidence of steam and further Maillard browning reactions occur. While maintaining product circulation, cold water is circulated through the service side of the heat exchangers, to reduce the product temperature to around 55° C. The product is then removed from the system via an outlet (8) or may be removed via a drain (12). The browned milk solids can then be separated from the fat using one of the methods described above.

The aqueous material may be added in more than one step, and each addition step may be carried out at different temperatures if desired.

For example, in one embodiment, milkfat may be heated to 160° C. and half the cream added to the circulating milkfat. The milkfat temperature may then be reduced to 130° C. and the remainder of the cream can be added before the milkfat/milk solids slurry is cooled to 60° C. for removal of the solids. Cooling may be conveniently achieved using methods and apparatuses well known in the art, such as scraped surface heat exchangers, tubular heat exchangers and the like.

After removal of the browned milk solids (by filtration, decanting, or mechanical separation) the product can be de-aerated by vacuum treatment in a dehydrator at 40-100° C. (preferably 90° C.). The vacuum treatment removes air (oxygen) and improves the keeping quality of the concentrate. Alternatively inert gas such as nitrogen can be sparged into the product to remove the oxygen.

2.3 Exemplary Preparation of Flavour Concentrates in a Batch Operation with an External Heating Circuit

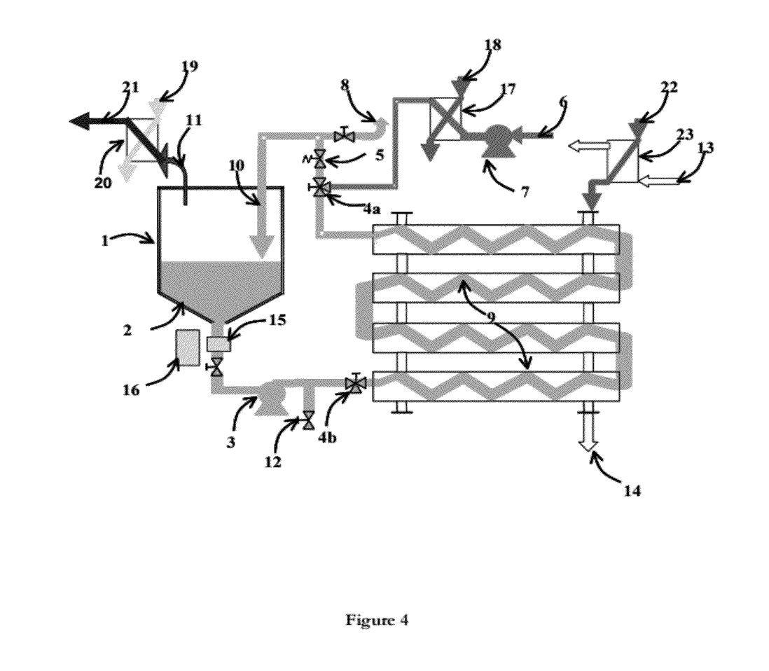

A further exemplary implementation of at least one aspect of the invention is described below with reference to FIG. 4.

FIG. 4 shows a schematic of the plant in which the process is implemented, again with an external heating circuit applied. The vessel (1) holds the lipid material (2) that is heated by external circulation using pump (3) through heat exchangers (9) to a temperature above the boiling point of the aqueous material under applied pressure. In this instance the lipid is heated at 135° C. The steam inlet (13), high pressure service water (22), the high pressure water heater (23), and the service water drain (14) are shown on the heat exchanger. The aqueous material (6) is introduced into the circuit after the heat exchangers via pump (7) and valve (4a) positioned close to back-pressure valve (5) set to give a pressure between 200 and 300 kPa (kilopascals). In this embodiment, the aqueous material is heated at approximately 70° C. to 80° C. prior to admixture by heater (17) using heating water (18). Alternatively, the aqueous material may be introduced before the external heat exchangers via valve (4b).

In the heat exchangers, the lipid material or mixture of lipid and aqueous materials is superheated. The milk solids-not-fat undergoes Maillard browning reactions and, on re-entering the reaction vessel via a product circulation return (10), the superheated water is converted immediately to steam.

The mixture is maintained at about 135° C. and below ambient pressure during admixing. Steam and other volatiles are flashed off and exit via an outlet (11), whereupon they are condensed in a condenser (20) using cooling water (19) to yield a condensed flavour concentrate (21). This condensation imparts a slight vacuum on the reaction vessel.

Once all the aqueous material is added, the heating is continued until there is minimal evidence of steam and further Maillard browning reactions occur. Reaction progress may be conveniently monitored using a sightglass (15) or colour sensor (16). While maintaining product circulation, cold water is circulated through the service side of the heat exchangers, to reduce the product temperature to around 80° C. This is conveniently achieved using the water heater (23). The product is then removed from the system via an outlet (8) or may be removed via a drain (12). The browned milk solids can then be separated from the fat using one of the methods described above.

### 3. Flavour Compounds

Exemplary compounds believed to be important to the flavour profile associated with flavour concentrates of the present invention are described below.

### 3.1 Lactose Fragmentation Compounds

For the product of the present invention, the most abundant class of volatile compounds, as well as the most important potent flavour compounds are believed to come from lactose fragmentation. Lactose fragmentation can occur through (i) Maillard reactions (which requires both a source of primary or secondary amines (eg protein) and sugar), and/or (ii) caramelisation reactions (which requires sugar but do not require protein) (see Wadodkar U R, Punjrath J S & Shah A C (2002). Evaluation of volatile compounds in different types of ghee using direct injection with gas chromatography-mass spectrometry. Journal of Dairy Research, 69, pp 163-171). For traditional ghee from made butter, lactose fragmentation compounds are still amongst the most important classes of potent flavour compounds, although their concentrations are lower than those found in the flavour concentrate described herein.

Some of the most relevant lactose fragmentation compounds for the flavour concentrate described herein include: furfural, maltol, furaneol, homofuraneol, and 3,4-dihydroxyhex-3-en-2,5-dione. Another lactose fragmentation compound, that is more abundant in the flavour concentrate described herein than in traditional ghee made from butter, is acetol (hydroxyacetone). Maltol is known as an important flavour compound of heated butter (see Sulser H & Buchi W (1969), Volatile acids in browned butter. Leitschrift fur Lebesmittel-untersuchung and Forschhung, 141(3) pp 145-149).

### 3.2 Milkfat Hydrolysis Compounds

The most abundant classes of volatile compounds of traditional ghee are methyl ketones and carboxylic acids. These two classes of compounds are both present in unheated milkfat, but at relatively low levels. However, when the milkfat is heated, for example during manufacture of traditional ghee, the relative levels of both methyl ketones and carboxylic acids increases.

The formation of methyl ketones (such as pentan-2-one and heptan-2-one) is dependant upon the hydrolysis (with water) of the glyceryl β-ketocarboxylate component of the milkfat, and subsequent decarboxylation of the resulting β-ketocarboxylic acids. Formation of carboxylic acids (such as butyric acid) is dependant upon the hydrolysis (with water) of the glyceryl carboxylates component of milkfat. Even though glyceryl β-ketocarboxylates are only a minor component of milkfat, the rate of hydrolysis of β-ketocarboxylate esters is much greater than that of carboxylate esters, and therefore leads to an abundance of methyl ketones as volatiles in traditional ghee (see Waldhawa B K & Jain M K (1990). Chemistry of Ghee Flavour—A Review. Indian Journal of Dairy Science, 43 (4)).

### 3.3 Marker Compounds

The applicants have determined that flavour concentrates produced by the methods of the invention exhibit an elevation in compounds such as but not limited to maltol, acetol, furfural when compared to the starting materials or to the products of many traditional ghee manufacturing methods. Similarly, the flavour concentrates produced by the methods of the invention can exhibit a decrease in lipid hydrolysis products (depending on the conditions used), such as but not limited to free fatty acids and methyl ketones, when compared to the starting materials or to the products of traditional ghee manufacturing methods.

Accordingly, in another aspect of the invention is a flavoured composition comprising or consisting of

a cooked combination of a lipid material and an aqueous material

wherein the lipid material is one or more of a dairy, animal or vegetable fat or oil and the aqueous material comprises one or more sugars and one or more proteins, and optionally one or more lipids or a fermentate, and

wherein the composition includes one or more of the compounds substantially as follows:

1-100 μg/g furfural (CAS [98-01-01]),

0.1-10 μg/g 3,4-dihydroxyhex-3-ene-2,5-dione (DHHD) (CAS [10153-61-4]),

5-100 μg/g maltol (CAS [118-71-8]),

0.1-10 μg/g furaneol (CAS [3658-77-3]),

2-30 μg/g acetol (CAS [116-09-6]),

1-5 μg/g pentan-2-one (CAS [107-87-9]),

1-80 μg/g heptan-2-one (CAS [110-43-0]),

0.1-100 μg/g 3-methylbutanal (CAS [590-86-3]), or

0-10 μg/g 2-methylbutanal (CAS [96-17-3]).

In various embodiments, the composition includes one or more of the compounds substantially as follows:
at least about 3 μg/g furfural, preferably at least about 5, about 10, about 15 or about 20 μg/g furfural,
at least about 0.2 μg/g DHHD, preferably at least about 0.5, about 1, about 1.5 or about 2 μg/g DHHD,
at least about 7.5 μg/g maltol, preferably at least about 10, about 15, about 20 or about 25 μg/g maltol,
at least about 0.2 μg/g furaneol, preferably at least about 0.5, about 1, about 1.5, about 2, or about 2.5 μg/g furaneol,
at least about 2 μg/g acetol, preferably at least about 2.5, about 3, about 3.5, or about 12 μg/g acetol,
less than about 20 μg pentan-2-one, preferably less than about 15, about 10, about 6, about 5, or less than about 4 μg/g pentan-2-one,
less than about 50 μg/g heptan-2-one, preferably less than about 40, about 35, about 30, about 25, or less than about 20 μg/g heptan-2-one,
at least about 0.2 μg/g 3-methylbutanal, preferably at least about 0.25, about 0.3, about 0.4, about 0.5, or about 6 μg/g 3-methylbutanal, or
at least about 0.1 μg/g 2-methylbutanal, preferably at least about 0.15, about 0.2, about 0.25, about 0.3, about 0.35, or about 0.4 μg/g 2-methylbutanal.

In various embodiments, the composition comprises two or more, three or more, four or more, five or more, six or more, seven or more, eight or more, or all nine of the above compounds.

For example, one exemplary composition comprises

1-100 μg/g furfural, and

0.1-10 μg/g 3,4-dihydroxyhex-3-ene-2,5-dione [DHHD].

In another example, the composition comprises

1-100 μg/g furfural and

5-100 μg/g maltol.

In another example, the composition comprises

5-100 μg/g maltol,

0.1-10 μg/g furaneol, and

0.5-100 μg/g 3-methylbutanal.

As will be appreciated, each of the 9! possible permutations or combinations of the above compounds are expressly contemplated as if individually set forth herein.

In various embodiments of the present invention a concentrate product is produced having flavour characteristics selected from any one or more of toffee flavour, butterscotch flavour, baked biscuit flavour, caramel flavour, and malt flavour, flavours associated with roasted nuts, heated/roasted popcorn, fried potato chips, baked unleavened breads, flavours associated with roasted meat, blue cheese or cooked pizza.

Table 1 below presents a summary of the concentrations of various marker compounds present in exemplary samples of AMF, Ghee, and concentrates of the present invention as described in Examples 1 to 5. Concentrations were determined using a headspace/solid phase microextraction/gas chromatography method, with gas chromatography conditions as per Bendall J G (2001), “Aroma compounds of fresh milk from New Zealand cows fed different diets”, Journal Of Agricultural And Food Chemistry 49 (10): 4825-4832 October 2001.

TABLE 1
Exemplary concentrations of marker compounds

| | | | Lipid Flavour |
|---|---|---|---|
| | | | concentrate made |
| Compound | AMF | Ghee* | from cream |
| Furfural (μg/g) | <0.1 | 0.1-3 | 3-30 |
| DHHD (μg/g) | <0.1 | <0.1 | 0.1-10 |
| Maltol (μg/g) | <0.1-2 | 1.5-7.5 | 10-60 |
| Furaneol (μg/g) | <0.1 | <0.1 | 0.1-5 |
| Acetol (μg/g) | <0.1 | 0.2-2 | 2-30 |
| pentan-2-one (μg/g) | 0.1-10 | 15-40 | 0.5-5 |
| heptan-2-one (μg/g) | 2-10 | 40-80 | 15-80 |
| 3-methylbutanal (μg/g) | <0.1 | <0.1 | 0.1-10 |
| 2-methylbutanal (μg/g) | <0.1 | <0.1 | 0.1-0.5 |

*made from butter

As can be seen in Table 1, the concentration of the exemplary methyl ketones pentan-2-one and heptan-2-one present in the flavour concentrate of the present invention is at the lower limit or below that present in ghee made from butter. Similarly, the concentration of exemplary desired flavour compounds, such as furfural and maltol, is substantially higher in the flavour concentrate of the present invention compared to that present in ghee from butter.

### 3.4 Effect of Fermentation

It is well known in the art that fermentation by different micro-organisms results in differences in the concentrations or amounts of the fermentation products produced thereby. For example, the fermentation of the aqueous material, for example dairy cream, to be used for flavour concentrate manufacture alters the relative concentrations of some of the lactose fragmentation compounds, and that these relative concentrations may differ depending on the organism or organisms used for the fermentation. Preferred organisms include acid, lipase and protease secretors, such as lactic acid secretors, or combinations or metabolites thereof. Examples of such preferred organisms include strains from the mesophilic cheese starter species Lactococcus lactis subsp. lactis and Lactococcus lactis subsp. cremoris. Further examples of organisms suitable for use in the present invention include other lactococcus species such as Lactococcus lactis subsp. diacetylactis, Leuconostoc species including, for example, Leuconostoc cremoris, Streptococcus thermophilus, and Lactobacillus species including Lactobacillus delbrueckii subsp. bulgaricus, Lactobacillus acidophilus, Lactobacillus helveticus, Lactobacillus lacus, Lactobacillus rhammosis, and Bifidobacterium species. Fungi may also be used in the preparation of a culture for use in the present invention. Preferred organisms are those producing or increasing the amount or concentration of desired flavour compounds or the precursors of desired flavour compounds in the aqueous material or the flavour concentrate. For example, in certain embodiments micro-organisms that produce or increase the concentration of a class of compounds of which 2-methylbutanal and 3-methylbutanal are examples in the flavour concentrate, are preferred. These compounds can impart a desirable malty or nutty flavour character.

Accordingly, in one embodiment of the present invention the aqueous material is or includes a product from a culture or a fermentation. In one embodiment, the culture source is cultured yoghurt. In preferred embodiments, the aqueous material is a cultured dairy material, such as a cultured cream.

In certain embodiments, the aqueous material is treated with an organism as described above. In other embodiments, the aqueous material is treated with one or more enzymes, one or more acids, or one or more bases, or combinations thereof. Suitable enzymes include lipases and proteases. Suitable acids are well known in the art and include food grade acids such as lactic acid and acetic acid. Suitable bases are also well known in the art and include sodium hydroxide and potassium hydroxide.

Various aspects of the invention will now be illustrated in non-limiting ways by reference to the following examples.

### EXAMPLES

### Example 1

### Preparation of Flavour Concentrates

A butter concentrate with caramel/toffee flavours was produced that can be used in cooking to enhance the cooked/caramel butter flavours.

The process involved the heating of a lipid material with progressive addition of an aqueous material until the majority of the water had been driven off and the curds had browned to yield a caramel flavour.

600 g of Meadowfresh cream (pasteurised, 40% fat) sourced from Meadow Fresh Limited, New Zealand, was weighed into a glass beaker and heated to 50° C. in a waterbath.

600 g of Anhydrous Milkfat (AMF) sourced from Fonterra Cooperative Group Ltd (Manufactured at Edgecumbe site, 23/5/05) was placed in a stainless steel beaker and heated with a gas camping burner. A temperature probe was immersed into the AMF ensuring that the probe did not touch the bottom of the beaker. The AMF was stirred using an overhead laboratory stirrer.

The AMF was heated to 120° C., the gas flow was adjusted to maintain the temperature and the cream was slowly added through a dropping funnel while stirring at sufficient speed to rapidly disperse the cream and at a rate that maintains the temperature at 120° C. and allowed the water to boil off.

When most of the water had evaporated, the temperature was allowed to rise to 135° C. under vigorous stirring. The temperature was maintained until the curds had stopped bubbling and taken on a reddish-brown colour.

The gas was turned off and the mixture was cooled to 50° C. by stirring at room temperature.

The mixture was filtered using a stainless steel funnel lined with a two layers of folded paper towel to produce a lipid flavour concentrate free from browned particles.

Three samples were produced and are summarised in Table 2. Sample 1 was the AMF used to produce Sample 3 with no further processing. Sample 1 was representative of most ghee available in the market place. Sample 3 was produced as outlined above. Sample 2 was produced in a similar way to Sample 3 with the exception that the AMF was replaced with unsalted New Zealand butter and that no aqueous material was added. The production of Sample 2 is representative of mass produced ghee made from butter and beurre noir/beurre Noisette. Sample 4 was produced in the same way as Sample 3, using different batches of raw materials.

TABLE 2
Lipid and aqueous starting materials
for flavour concentrate manufacture

| Sample # | Lipid Material | Aqueous Material |
|---|---|---|
| 1 | AMF | Nil |
| 2 | Butter | Nil |
| 3 | AMF | Natural Cream |
| 4 | AMF | Natural Cream |

Sensory evaluation of these samples showed that Samples 3 and 4 had markedly higher levels of cooking related flavours and aromas described as toffee, butterscotch, baked biscuit and caramel in comparison with Sample 1 (AMF) without any diminishment of cream flavour and without increase in aged related flavours. Sample 2 had increased levels of cooking related flavours than Sample 1 but these were much lower than those for Samples 3 and 4.

The samples were analysed for flavour compounds as follows. Concentrations were determined using a headspace/solid phase microextraction/gas chromatography method, with gas chromatography conditions as per Bendall J G (2001), “Aroma compounds of fresh milk from New Zealand cows fed different diets”, Journal Of Agricultural And Food Chemistry 49 (10): 4825-4832 October 2001. The results of this analysis are shown in Table 3 below.

TABLE 3
Flavour chemistry analysis

| Compound | Sample 1 | Sample 2 | Sample 3 | Sample 4 |
|---|---|---|---|---|
| 3-Methylbutanal (μg/g) | <0.1 | <0.1 | 0.1 | 0.6 |
| 2-Methylbutanal (μg/g) | <0.1 | <0.1 | 0.1 | 0.3 |
| Furaneol (μg/g) | <0.1 | <0.1 | 0.5 | 0.9 |
| Maltol (μg/g) | 1.8 | 1.5 | 25 | 26 |
| Furfural (μg/g) | <0.1 | 0.8 | 17 | 21 |
| DHHD (μg/g) | <0.1 | <0.1 | 0.4 | 1 |

Table 3 shows that Samples 3 and 4 had elevated levels of key flavour chemicals (such as maltol and furfural) in comparison with Sample 1, which resulted in increased flavour profile. Sample 2 showed minimal elevation of these key flavour chemicals indicating a much weaker flavour profile than Samples 3 and 4.

### Example 2

### Preparation of Flavour Concentrates Using Batch Process with Internal Heating

This example describes the preparation of flavour concentrates using the batch process with internal heating as described above.

15 kg of Anhydrous Milkfat was heated to 120° C. in a jacketed vessel as shown in FIG. 2. 12 kg of pasteurised cream (≈40% fat) was pumped into the vessel at a rate of approximately 15 kg/hour and the process was allowed to proceed until no further steam was evolved. When all the cream was used, the temperature of the vessel was raised to 140° C. for 5 minutes to complete the Maillard browning reactions. The vessel contents were then cooled to 55° C., by introducing cold water into the vessel jacket. The contents were then removed and the solids separated by filtration through a GAFF filter to produce a lipid flavour concentrate.

This flavour concentrate had flavour and aroma characteristics similar to those of Samples 3 and 4 from Example 1, and had higher levels of cooking related flavours in comparison with the starting material AMF.

### Example 3

### Preparation of Flavour Concentrates Using Batch Process with External Heating

This example describes the preparation of flavour concentrates using the batch process with external heating and the point of cream introduction being before the heat exchanger as described above with reference to FIG. 3.

52 kg of Anhydrous Milkfat was placed in the holding vessel and the circulation pump turned on at approximately 2500 kg/hour. Steam was applied to the heat exchangers and the temperature of the fat raised to 140° C. The back-pressure valve was set to 400 kPa. When the temperature at the exit of the heat exchangers reached 140° C., the cream pump was turned on and the cream flow set to 60 kg/hour. 30 Kg of pasteurised cream (40% fat) was added. The temperature was maintained at 140° C. during addition and for 5 minutes after all the cream had been added. At this time, the service steam was turned off and cold water introduced into the service side of the heat exchangers to bring the temperature of the circulating mixture of browned milk solids and fat to 55° C. The browned milk solids were then separated from the fat using a Sharples decanter to produce a lipid flavour concentrate.

This lipid flavour concentrate had flavour and aroma characteristics similar to those of both Samples 3 and 4 from Example 1 and the material produced in Example 2. Again, higher levels of cooking related flavours in comparison with the parent AMF were described.

### Example 4

### Preparation of Flavour Concentrates Using Batch Process with External Heating

This example describes the preparation of another flavour concentrate using the batch process with external heating and the point of cream introduction being before the heat exchanger as described above with reference to FIG. 3.

0.45 kg lactose and 0.45 kg lactose hydrolysed milkpowder were added to 30 kg pasteurised cream (40% fat). The mixture was blended by stirring vigorously at 20° C. to hydrate the powder and dissolve both ingredients in the aqueous phase of the cream. The addition of the lactose and lactose hydrolysed milkpowder increased the lactose content of the cream from 3% by weight to approximately 6-7% by weight and increased the combined glucose and galactose content from 0% by weight to 1-2% by weight. The cream was added to 52 kg anhydrous milkfat and processed under the same conditions as described in Example 3 above to produce a lipid flavour concentrate.

The resulting flavour concentrate had strong caramel/butterscotch flavours.

### Example 5

### Preparation of Flavour Concentrates Using Batch Process with External Heating

This example describes the preparation of a further flavour concentrate using the batch process with external heating as described in Example 3 above. However, in this example, two addition steps for the aqueous material were performed. Further, the composition of the aqueous material used for the second addition step was modified.

52 kg of AMF was heated to approximately 160° C. by recirculation around the heat exchanger loop at approximately 2500 kg/hour, and 15 kg sweet cream was added at 60 kg/hour using the homogenising valve set at 300 kPa. When all the cream has been pumped in, and no more steam was emitted, the product was held at temperature for 10 minutes and then the temperature was reduced to 130° C. A further 15 kg cream to which 450 g each of lactose and hydrolysed milkpowder had been added was then added to the lipid mixture at the same flowrate. When all the cream had been added and no more steam was emitted, the product was held for 5 minutes and then cooled to 55° C.

The lipid flavour concentrate was analysed for flavour compounds using the methods described in Example 1 above after separation. The results are shown in Table 4 below.

TABLE 4
Flavour chemistry analysis

| Compound | Sample |
|---|---|
| 3-Methylbutanal (μg/g) | <0.1 |
| 2-Methylbutanal (μg/g) | <0.1 |
| Furaneol (μg/g) | 2.2 |
| Maltol (μg/g) | 17.3 |
| Furfural (μg/g) | 20.5 |
| DHHD (μg/g) | 2.2 |

The flavour concentrate produced using this method had strong caramel/butterscotch flavours.

### Example 6

### Sensory Evaluation of Flavour Concentrates

Samples 3 and 4 as described in Example 1 and presented in Table 3 were diluted in AMF to 20% by adding 40 ml of melted sample to 160 ml of melted AMF. Each sample was compared to the other samples and to a control standard AMF by a tasting panel to determine any differences in sensory profile.

Panellists were familiarised with the flavour attributes described in Table 5 below before the sensory evaluation.

TABLE 5
Flavour Attribute Definitions

| Attribute | Definition |
|---|---|
| Sweet | A basic taste associated with sucrose |
| Salt | A basic taste associated with sodium chloride or table salt |
| Cream | The flavour associated with New Zealand origin UHT |
| | cream. |
| Toffee | A flavour associated with toffee (Walker's Toffee) |
| Butterscotch | The flavour associated with butterscotch |
| Baked | The flavour associated with home baking e.g. Home made |
| biscuit | hokey pokey biscuits |
| Caramel | The flavour associated with sugar that has been cooked |
| | exemplified by condensed milk that has been boiled in |
| | the tin |
| Malt | The flavour associated with malt (Mackintosh malt lolly) |
| Oxidised | A general term related to various characteristics of oxidised |
| | foods - such as stale, rancid, painty and tallow |
| Lactic | The flavour associated with sour cream, cream cheese or |
| | acidophilus Yoghurt |
| Cheesy | The flavours associated with cooked cheddar cheese |
| Scorched/ | The flavour associated with burnt butter |
| burnt | |
| Cowy | A flavour reminiscent of cows, farm animals and their |
| | environments e.g. cowshed, cow breath, barny, wet dog, |
| | wet wool, etc. |

Each panellist received approximately 20 ml of each anhydrous liquid butter sample, served at 40° C.

The panellists were instructed to rate each sample for the 13 flavour attributes (sweet, salt, creamy, toffee, butterscotch, baked biscuit, caramel, malt, oxidised, lactic, cheesy, scorched/burnt, cowy). An ‘other’ category was also available for panellists to identify any extra flavours not covered by the 12 attributes.

The panellists rated all samples in individual booths under red lights. Between each sample there was a one minute time delay where the panellists cleansed their palates with 24° C. filtered water and soda water and ‘Crisp’ Fresh up apple juice.

The standard AMF sample had a sensory profile that was creamy and lacked the toffee, butterscotch, baked biscuit, and caramel or scorched/burnt flavours found in samples 3 and 4.

### Example 7

### Preparation of Flavour Concentrates Using Daily and Non-Daily Materials

This example describes the preparation of lipid flavour concentrates using non-dairy materials and combinations of dairy and non-dairy materials.

Eight flavour concentrate variants were made using a variety of starting materials as outlined in Table 6. Some of the aqueous materials as indicated in Table 6 were fermented. The stated amount was heated to 30° C. and 1% Danisco Flora Danica starter culture was dispersed into it. This mixture was fermented overnight at 30° C. to give the pH indicated in Table 6. These aqueous phases were heated to 60° C. prior to use.

In each case, the lipid material was placed in a open vessel and heated with a gas burner. A temperature probe was immersed into the lipid material ensuring that the probe did not touch the bottom of the vessel. The AMF was stirred using a spatula.

The lipid was heated to approximately 120° C., the gas flow was adjusted to maintain the temperature and the aqueous material was slowly added using a pipette with stirring at sufficient speed to rapidly disperse the cream and at a rate that maintains the temperature at approximately at 120° C. and allowed the water to boil off.

When most of the water had evaporated, the temperature was allowed to rise to approximately 130° C. under vigorous stirring. The temperature was maintained until the curds had stopped bubbling and taken on a reddish-brown colour. The holding times used are shown in Table 6.

The gas was turned off and the mixture was cooled to 80° C. by placing the mixture in a stainless steel beaker and immersing this in a mixer of ice and water. The mixtures were then filtered using a stainless steel funnel lined with a two layers of folded paper towel to produce flavour concentrates free from browned particles.

Seven samples were produced and are summarised in Table 6. The samples were made using the method of the invention and a variety of lipid and aqueous materials, as described in Table 6. The samples made using soy milk and orange juice produced very sticky solid residue which dried to produce coarse chunks. As shown in Table 6, the cream used in the preparation of samples 5 and 7 was fermented with Flora Danica culture, an exemplary mixed lactic acid starter culture typical of those used in the preparation of cultured dairy materials.

TABLE 6
Flavour concentrate manufacture

| Sample | | | | Holding time at |
|---|---|---|---|---|
| # | Lipid Material | Aqueous Material | Fermentation | 130° C. (min) |
| 1 | 300 g Canola oil | 300 g of 25% solution | Fora Danica, | 1 |
| | | of buttermilk powder | pH = 4.76 | |
| 2 | 300 g Tallow | 300 g Vitasoy soy milk | None | 12 |
| 3 | 300 g AMF | 300 g Vitasoy soy milk | None | 13 |
| 4 | Coconut oil | 280 g Orange juice and | None | 2.2 |
| | | 20 g gluten powder | | |
| 5 | 300 g AMF | 300 g cream | Fora Danica, | 8 |
| | | | pH = 4.40 | |
| 6 | 300 g AMF | 300 g of 25% solution | Fora Danica, | 3.5 |
| | | of buttermilk powder | pH not recorded | |
| 7 | 300 g Canola oil | 300 g cream | Fora Danica to | 6 |
| | | | pH not recorded | |

The source of the lipid and aqueous materials used in this example is presented in Table 7 below. As can be seen, all are readily available products and are representative of the materials that are suitable for use in the present invention.

TABLE 7
Lipid and aqueous starting materials for flavour concentrate manufacture

| | Product | | | | |
|---|---|---|---|---|---|
| Material | Name | Source | Brand | Manufacturer | Code |
| Canola oil | Canola | Supermarket | Sunfield oils | Tasti Products, | Best |
| | | | | Auckland, New | before |
| | | | | Zealand | 13 Feb. 2009 |
| Tallow | Chefade | Supermarket | Chefade | Unilever, | Best |
| | | | | Petone, New | before |
| | | | | Zealand | 07 Oct. 2008 |
| Hydrogenated | Kremelta | Supermarket | Kremelta | Peerless | Best |
| Coconut oil | Vegetable | | | Holdings Pty, | before |
| | Shortening | | | Braybrook, | 03 Oct. 2008 |
| | | | | Victoria | |
| | | | | Australia. | |
| Soy milk | Vitasoy | Supermarket | Vitasoy | Vitasoy | Best |
| | Creamy | | | Australia | before |
| | Original | | | Products Pty, | 04 Sep. 2008 |
| | | | | Melbourne, | |
| | | | | Australia | |
| Wheat gluten | Fine ground | Supermarket | Healtheries | Healtheries of | Best |
| | Gluten | | | New Zealand | before |
| | Flour | | | Ltd. Auckland, | November 2010 |
| | | | | New Zealand. | |
| AMF | FFMR | Fonterra | NZMP | Fonterra, | 4172, |
| | | | | Auckland. New | BQ30, |
| | | | | Zealand | E1421. |
| Orange Juice | Real Orange | Supermarket | McCoy | Frucor, | Best |
| | Juice | | | Auckland. New | before |
| | | | | Zealand | 04 Nov. 2008 |
| Cream | Cream | Supermarket | Meadowfresh | Meadowfresh, | Not |
| | (pasteurised, | | | Dunedin, New | recorded |
| | 40% fat) | | | Zealand | |
| Buttermilk | Spray dried | Fonterra | NZMP | Fonterra, | 4777 |
| powder | buttermilk | | | Auckland. New | JR24, |
| | powder | | | Zealand | J9374 |

The results of sensory evaluation of these lipid flavour concentrate samples is shown below in Table 8. In all cases the method of the invention improved the flavour of the starting oils—for example, unpleasant beany flavours found in the canola oil, tallow and coconut oils were not detected in the flavour concentrates. The flavour concentrates based on milkfat had sweet toffee, caramel and baked biscuit flavours. The flavour concentrates based on other oils had more savoury fried batter and doughnut flavours. A strong fried mushroom flavour was developed in Sample 4. Culturing of the cream used to make these samples enhanced the flavour profiles of the samples by imparting cultured flavours to the products. These samples illustrate the wide range of flavours that can be generated by the invention.

TABLE 8
Flavour profiles of lipid flavour concentrates

| Sample | Aroma Comments | Flavour Comments |
|---|---|---|
| Canola Oil | | Beany, unpleasant |
| Tallow | | Beany, unpleasant |
| AMF | | Buttery, creamy |
| Coconut Oil | | Bland, slightly beany. slight nutty |
| Sample 1 Canola/BMP | Sweet/cooked | Fried food, fried batter. |
| Sample 2 Tallow/Soy Milk | Doughnuts, biscuits | Cooked, sweet, savoury, oil used |
| | cooking | for deep frying |
| Sample 3 AMF/Soy Milk | Sweet/cooked | Like biscuits, crackers, baked |
| Sample 4 Coconut | Fried mushrooms | Roast peanuts, fried mushrooms, |
| Oil/Orange Juice/Gluten | | crispy bits in frying pan. |
| Sample 5 AMF/Cream | Caramel/toffee | Caramel, toffee, fudge, baked |
| | | biscuit. Slight scorched. |
| Sample 6 AMF/BMP | Caramel/cultured | Cooked biscuit, caramel, cultured |
| Sample 7 Canola/Cream | Fried batter | Fried batter. plastic |

The starting lipid materials used in this example and the lipid favour concentrate samples produced as described above were analysed for flavour compounds using the method outlined in Example 1. The results of the analyses of the starting lipid materials are shown in Table 9 below, while the results of the analyses of the various flavour concentrate samples are shown in Table 10 below.

TABLE 9
Flavour chemistry analysis - starting lipid material

| Compound (μg/g) | Canola Oil | Tallow | Coconut Oil |
|---|---|---|---|
| 3-Methylbutanal | <LOD | 0.3 | <LOD |
| Pentan-2-one | 0.7 | 2.3 | 0.4 |
| Heptan-2-one | 0.2 | 0.4 | 0.1 |
| Acetol | 0.2 | 1.1 | 0.4 |
| Furfural | 0.03 | 0.05 | 0.02 |
| DHHD | <LOD | <LOD | <LOD |
| Maltol | 0.72 | 1.5 | 0.5 |
| Furaneol | <LOD | <LOD | <LOD |

TABLE 10
Flavour chemistry analysis - flavour concentrates

| Compound | Sample | | | | | | |
|---|---|---|---|---|---|---|---|
| (μg/g) | 1 | 2 | 3 | 4 | 5 | 6 | 7 |
| 3-Methylbutanal | 0.49 | 9.5 | 1.9 | 0.3 | 2.1 | 1.7 | 2.6 |
| Pentan-2-one | 0.1 | 0.3 | 1.7 | 0.1 | 1.2 | 6.2 | 0.4 |
| Heptan-2-one | 0.1 | 0.1 | 13 | 0.2 | 1.5 | 16 | 8.8 |
| Acetol | 6.2 | 8.2 | 8.8 | 10 | 7.7 | 15 | 6.8 |
| Furfural | 8.6 | 0.55 | 0.44 | 4.7 | 4.9 | 8.2 | 4.9 |
| DHHD | 0.09 | <LOD | <LOD | 7.5 | 1.5 | 1.4 | 2.1 |
| Maltol | 21 | 8.8 | 7.7 | 2.3 | 14 | 17 | 14 |
| Furaneol | 0.84 | 0.16 | 0.18 | 0.12 | 0.76 | 0.96 | 0.75 |

As can be seen in Tables 9 & 10, the method of the invention substantially increased the levels of key flavour chemicals in the samples in comparison with the parent oils. In particular, high levels of maltol were observed in Sample 1, high levels of DHHD were observed in Sample 4, a high level of 3-methylbutanol was observed in Sample 1, and high levels of furfural were observed in Samples 1 and 4 and those derived from milkfat (Samples 5-7).

### Example 8

### Preparation of Lipid, Condensed and Solids Flavour Concentrates

This example describes the preparation of lipid, condensed and solids flavour concentrates using a process in which the second heating step is conducted at a temperature lower than the first heating step. A batch process with external heating was used, where the aqueous material was introduced before the heat exchanger, as described above with reference to FIG. 3 and as shown in FIG. 4.

45 kg of molten Anhydrous Milkfat derived from whey cream (Fonterra Co-operative Group Limited, NZ) was placed in the holding vessel and was circulated by the circulation pump at approximately 2500 kg/hour. Steam was applied to the heat exchangers and the lipid material was heated to 120° C. The back-pressure valve was set to 300 kPa. When the temperature of the lipid material at the exit of the heat exchangers reached 120° C., the aqueous pump was turned on and 45 kg of pasteurised cream (40% fat) at 40° C. was added at a flow rate of 55-60 kg/hour. Vapour was extracted from the reaction vessel and condensed using a heat exchanger cooled using cold water, as depicted in FIG. 4. This condensate was collected as a condensed flavour concentrate. The temperature was maintained at 120° C. during addition and subsequently maintained at 120° C. for approximately 5 minutes after all the cream had been added.

The temperature of the mixture was then allowed to fall to 115° C. and samples were packed off after holding at 115° C. for 0, 5, 10, 20, 30 and 40 minutes. Samples were cooled in ice water on removal.

The samples were then held for several hours in an oven at 50° C. and allowed to settle. The substantially clear lipid phase was then decanted from the top of the samples to produce lipid flavour concentrates. The sediment layers were retained as solids flavour concentrates.

Flavour profiles of the solids flavour concentrates were evaluated by dispersing 4 g (8%) of the solids into 46 g of Nestle Highlander Sweetened Condensed Milk (Auckland, New Zealand) with a spoon. Dispersal in this way was chosen as a good way to evaluate the cooked flavour notes of the solids flavour concentrates, and was exemplary of applications similar to a caramel sauce. The lipid flavour concentrates were melted and evaluated for flavour without addition or further modification.

Table 11 below shows that solids flavour concentrate imparted desirable caramel and Russian fudge flavours into the sweetened condensed milk. Increased holding time at 115° C. gave stronger fudge flavours and a darker colour. Table 11 also shows a progression of flavour and aroma of the lipid flavour concentrates from buttery thorough caramel to baked biscuit with increasing holding time at 115° C. The condensed flavour concentrate had a strong aroma of blue cheese with cooked and cowy notes.

TABLE 11
Flavour profiles of flavour concentrates

| Sample # | | |
|---|---|---|
| (Holding | Lipid Flavour | Solids Flavour |
| Time, min) | Concentrate | Concentrate |
| Sample 1 | Aroma—Mild caramel | Mild caramel flavour. |
| (0 Minutes) | Flavour—More buttery | Richer and sweeter |
| | than AMF | than plain sweetened |
| | | condensed milk. |
| Sample 2 | Aroma—Mild caramel | Similar to above but |
| (5 Minutes) | Flavour—Rich Buttery | stronger. Slight |
| | flavour, stronger than | Russian fudge flavour. |
| | #1. Slight caramel | |
| Sample 3 | Stronger caramel aroma | Russian fudge flavour |
| (10 Minutes) | and flavour than Sample 2 | |
| Sample 4 | Stronger caramel aroma | Strong Russian fudge |
| (20 Minutes) | and flavour than Sample 4 | flavour |
| Sample 5 | Aroma—Moderate caramel | Stronger Russian fudge |
| (30 Minutes) | Flavour—Moderate caramel. | flavour than Sample 4. |
| | Malt. | |
| Sample 6 | Aroma—Moderate caramel | Stronger Russian fudge |
| (40 Minutes) | Flavour—Moderate caramel. | flavour than Sample 5. |
| | Baked biscuit. Slight | |
| | scorched | |

Table 12 below shows that the levels of key flavour compounds in the lipid flavour concentrate increased progressively with longer holding times at 115° C. Without wishing to be bound by theory, this is believed to be a result of the flavour producing reactions becoming more advanced. The levels of the flavour compounds were generally lower than those observed in Samples 2 and 4 from Example 1 above, despite much longer holding times. Again without wishing to be bound by any theory, this suggests that flavour development reactions occur more slowly at 115° C. than at 135° C., and that holding times at 115° C. need to be longer than 40 min to achieve the same levels of flavour compounds as are achieved in the relatively short holding times at 135° C.

TABLE 12
Flavour chemistry analysis of lipid flavour concentrates

| | Sample | | | | |
|---|---|---|---|---|---|
| Compound | 1 | 3 | 4 | 5 | 6 |
| (μg/g) | 0 min | 10 min | 20 min | 30 min | 40 min |
| 3-Methylbutanal | <LOD | <LOD | <LOD | 1.4 | 3.0 |
| Pentan-2-one | 2.0 | 1.4 | 1.1 | 1.3 | 1.2 |
| Heptan-2-one | 47 | 44 | 36 | 44 | 45 |
| Acetol | 7.1 | 9.3 | 6.2 | 11 | 12 |
| Furfural | 1.6 | 2.8 | 3.5 | 3.9 | 3.9 |
| DHHD | <LOD | <LOD | 0.04 | 0.50 | 0.53 |
| Maltol | 1.7 | 3.8 | 11 | 13 | 14 |
| Furaneol | 0.16 | 0.36 | 0.54 | 0.61 | 0.56 |

Table 13 below shows that the solid concentrate had similar levels of flavour compounds as those of the lipid flavour concentrate described above, with the exception of maltol which was present at higher concentration than in the corresponding lipid concentrate. Table 13 also shows significant levels of heptan-2-one and, furfural and maltol were present in the condensed flavour concentrate. The heptan-2-one is likely to be responsible for the blue cheese odour of this material.

TABLE 13
Flavour chemistry analysis of solids
and condensed flavour concentrates

| Compound (μg/g) | Solids | Condensate |
|---|---|---|
| 3-Methylbutanal | 2.4 | <LOD |
| Pentan-2-one | 1.7 | 0.1 |
| Heptan-2-one | 44 | 4 |
| Acetol | 6.9 | <LOD |
| Furfural | 3.1 | ~1 |
| DHHD | 0.21 | <LOD |
| Maltol | 11 | ~5 |
| Furaneol | 0.28 | <LOD |

### Example 9

### Use of Flavour Concentrates in Chocolate

This example describes an investigation of the use of flavour concentrates of the present invention as flavouring agents in chocolate. Traditional milk chocolate is manufactured using “crumb”. Crumb is typically manufactured through the addition of cocoa liqueur to sweetened concentrated milk and the application of heat to force Maillard browning reactions that result in the caramelised flavours desired by consumers of milk chocolate. Traditional crumb processes are highly energy dependent, expensive, and typically require significant infrastructure close to a milk supply. The flavouring concentrates of the present invention have the potential to replicate caramel flavours present in crumb chocolate without the significant burden of a crumb process.

Similar flavours in chocolate to those generated by the Crumb process can also be achieved by using pre-caramelised milk powders (referred to as caramelised or confectionery dairy based powders). These also use heating steps in the manufacturing process to force Maillard browning reactions that result in the caramelised flavours desired by consumers of milk chocolate. An example is Fonterra Caramelised Dairy Based Powder (referred to herein as CDBP)

### Methods

Milk chocolate consumers (n=39) were recruited to attend two sessions at Fonterra Research Centre. In the first session consumers were given a set of 13 milk chocolate samples which included commercial milk chocolate, chocolate with an exemplary flavour concentrate of the invention (exemplary flavour composition 300, also referred to herein as DF300) added, and chocolate with commercial flavours added to impart caramel, buttery, creamy and milky flavours, as set forth below and in Table 14.

The following milk chocolates were used in this trial:
1. a commercial chocolate formulated with Fonterra Caramelised Dairy Based Powder (CDBP),
2. a commercial manufacture of the same formulation with standard WMP, and
3. a commercial manufacture of the same formulation with standard WMP and 2% exemplary flavour composition 300 (referred to subsequently as DF 300)
   (These chocolates were standardised for fat content in their formulation using anhydrous milkfat).

Commercially available chocolate was melted. Flavourings, and exemplary flavour concentrate of the invention (DF300) was added to a subset of samples, and then poured into moulds. Once set the chocolate was flaked using a food processor. Consumers tasted the samples of flaked chocolate which were presented in blind-coded pottles with spoons.

Consumers sorted these samples into groups based on similarity of flavour and commented on the key flavours of each group. In the second session the consumers rated the intensity of the top ten key flavours (descriptors) of six of the thirteen samples in an incomplete block design, to limit their fatigue.

Statistical analysis of the sorting data (multidimensional scaling, MDS) and the descriptor intensity data (ANOVA) produced a perceptual map which described where the samples sat in space compared to one another, and a comparison of the intensities of the key flavours in each of the samples.

TABLE 14
Summary of sample treatments

| | Choc- | | |
|---|---|---|---|
| | olate | | Cocoa |
| Label | base | Flavouring | bean origin |
| A &G | 1 | Caramelised milk powder | Ghana |
| B | 1 | 4% exemplary flavour composition 300 | Ghana |
| F & J | 1 | 2% exemplary flavour composition 300 | Ghana |
| D | 3 | No added flavour (WMP base) | Ghana |
| E | 2 | 0.22% Firmenich Milk S flavour | Madagascar |
| C | 2 | No added flavour (WMP base) | Madagascar |
| H | 2 | 0.07% Firmenich Milk Caramel 502590 | Madagascar |
| | | A7 flavour | |
| I | 2 | 0.18% Firmenich Cream S flavour | Madagascar |
| K | 2 | 4% exemplary flavour composition 300 | Madagascar |
| L | 2 | 1.5% Butter buds dried cream extract | Madagascar |
| M | 2 | 0.6% Edlong Butter flavour | Madagascar |

### Results

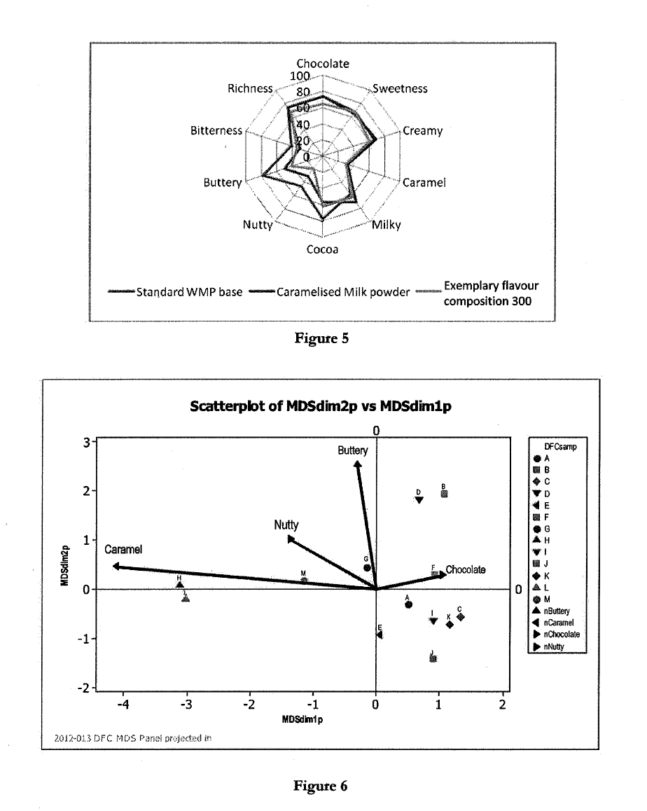

When a commercial chocolate made using CDBP was compared to chocolate made with standard WMP with 2% exemplary flavour composition 300 added, the addition of DF300 did not impart milky, buttery, creamy or chocolate intensities in excess of those perceived in the commercial chocolate formulation, as can be seen in FIG. 5. This demonstrated a closer flavour match to the commercial chocolate formulation compared with using standard WMP.

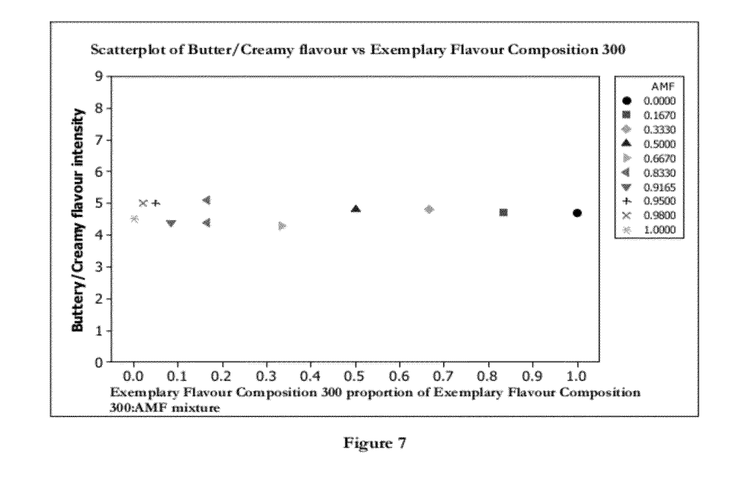

The consumer's placement of the chocolate samples relative to one another in the perceptual map (see the lower right-hand quadrant of MDS map, FIG. 6) indicated that the chocolate formulated with 2% DF300 was also a close flavour match to the commercial chocolate formulation.

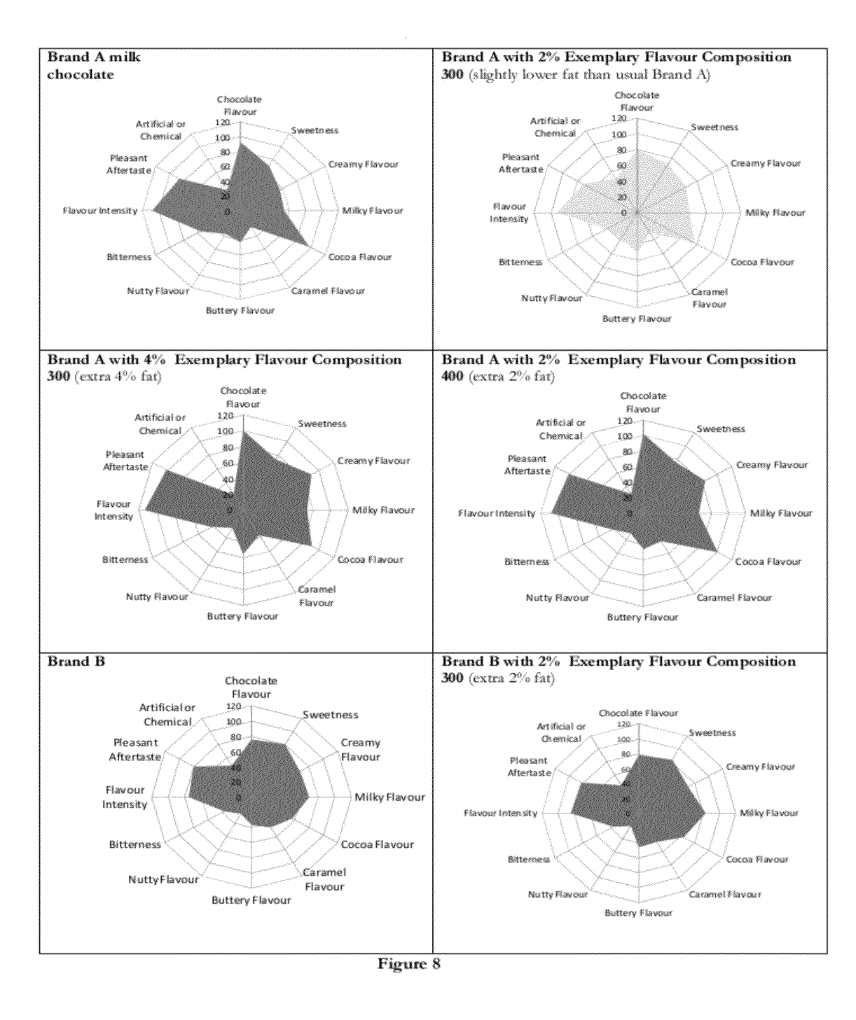

Trained sensory panel descriptive analysis (by Applicant's internal trained panel) indicated increasing the content of exemplary flavour composition DF300 in a mixture of DF300 and Anhydrous milkfat (AMF) did not increase the intensity of buttery/creamy flavours of the system. Hence exemplary flavour composition DF300 did not impart any buttery or creamy flavours to this system (FIG. 7).

### Example 10

### Use of Various Flavour Concentrates in Chocolate

### Introduction

This example describes an investigation of the flavour landscape of milk chocolate by presenting a range of milk chocolates available for sale in New Zealand to a group of 42 consumers, to which exemplary flavour concentrates of the invention were added to two of the six commercial brands evaluated, referred to as Brand A and B.

Commercial Brand A and B are known to be manufactured using CDBP, and the Crumb process, respectively.

### Methods

Commercially available chocolate was melted, flavourings, and exemplary flavour concentrates of the invention (DF300, DF400) were added to a subset of samples, and then poured into moulds. Once set the chocolate was flaked using a food processor. Consumers tasted the samples of flaked chocolate which were presented in blind-coded pottles with spoons.

Consumers sorted 12 samples in to groups based on similarity of flavour, and then on the second night they rated the intensity of 12 flavours (descriptors) for 8 of the 12 samples in an incomplete block design. Consumers were free to apply their own definitions of each flavour they measured. Samples were presented blind and identified only by 3-digit codes. The consumers were screened for milk chocolate consumption and ability to describe differences in milk chocolate flavours.

### Results

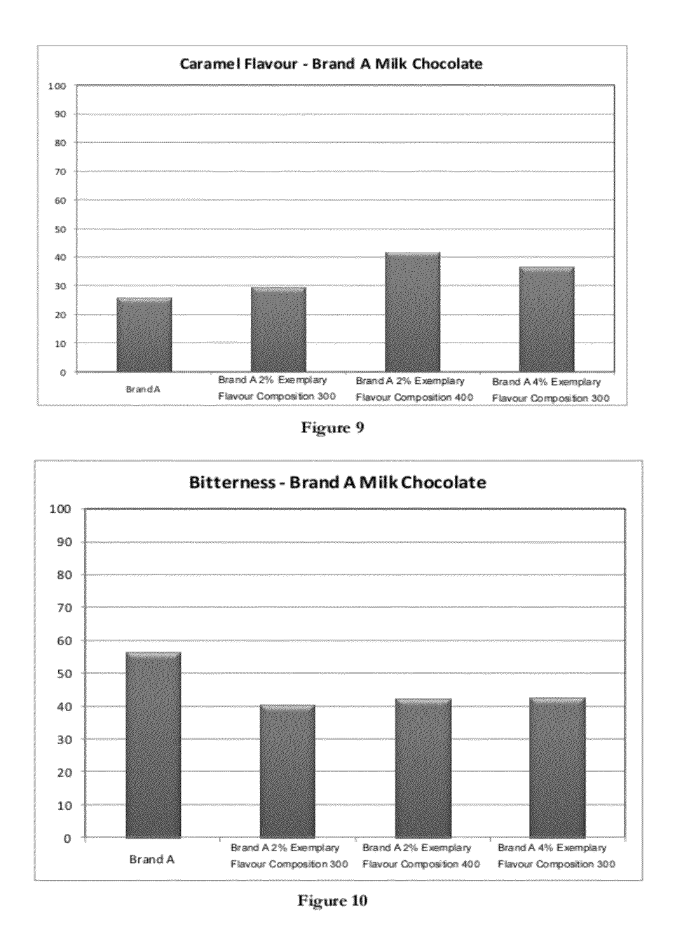

FIG. 8 presents the consumer sensory profiles of Brands A and B, and the samples of each which include exemplary flavour concentrate DF300. From this the difference made by the addition of exemplary flavour concentrates of the invention can be clearly seen.
Both exemplary flavour compositions DF300 and DF400 were added to Brand A, and as the charts in FIG. 8 show, altered the consumer sensory profile of Brand A.
Brand B flavour intensity was increased by the addition at 2% of the exemplary flavour concentrates DF300.

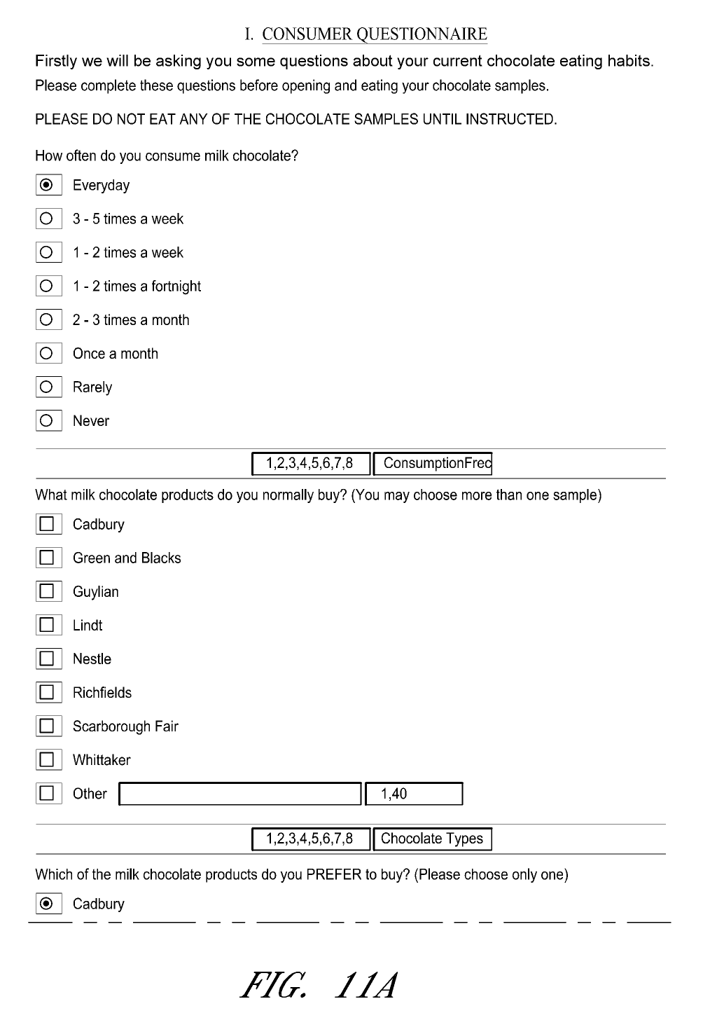

The mean consumer caramel flavour intensity is presented in FIG. 9. The addition of exemplary flavour concentrates of the invention increased the caramel intensity, with the largest increase from the addition of 2% DF 400. As described above, caramel is the key flavour associated with the crumb process.

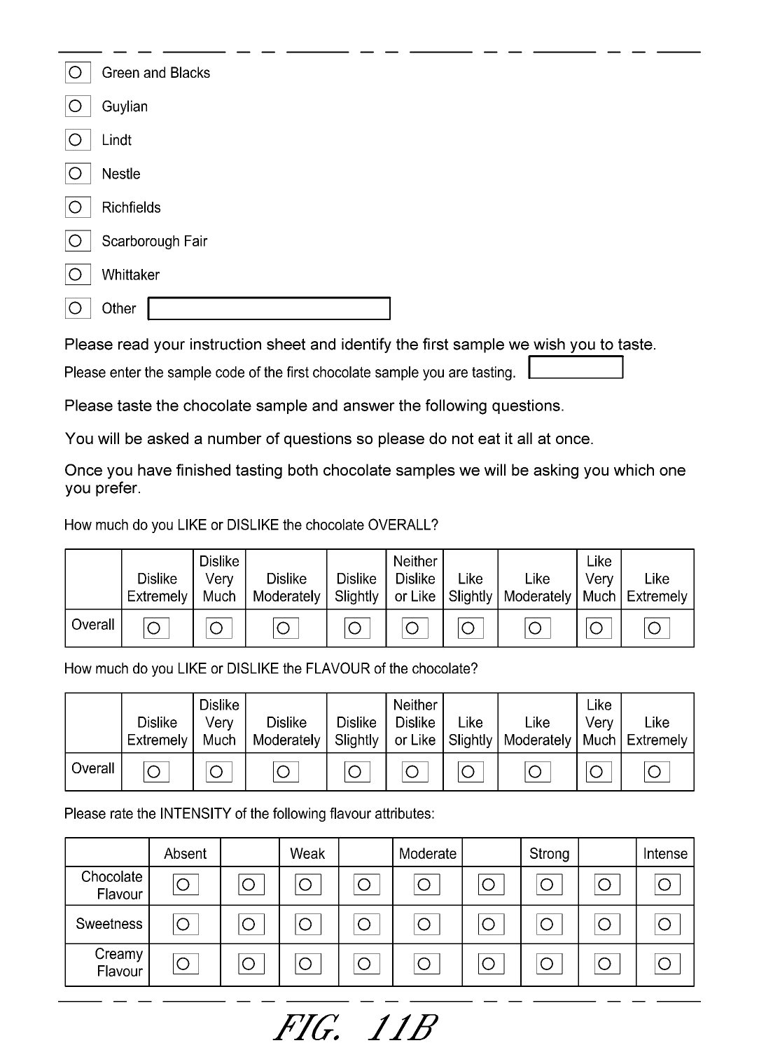

Bitterness was reduced in Brand A with the addition of exemplary flavour concentrates of the invention, as shown in FIG. 10. The rate of addition of DF300 or DF400 between 2-4% did not appear to have affected the reduction in bitterness.

### Example 11

### Introduction

This example describes two trials to investigate the consumer liking and sensory characteristics of prototype milk chocolates containing exemplary flavour composition 300 compared to Brand A Milk Chocolate formulation.

The key comparison in these trials was between the usual Brand A formulation which contains CDBP) used to impart caramel flavour to the chocolate, and an alternate formulation containing 2% exemplary flavour concentrate DF300 together with a standard Fonterra whole milk powder (WMP). As described herein, the production of caramel flavours are an important benefit of the chocolate ‘crumb’ process which is used extensively worldwide to manufacture milk chocolate. Brand A is not manufactured from ‘crumb’, but rather uses CDBP to assist in imparting these desirable flavours to the chocolate.

### Methods

### Acceptability and Attribute Intensity Testing

In both trials the acceptability and key consumer descriptors of each chocolate sample was measured. The trials tested if the acceptability and descriptor intensities were the same for each chocolate formulation. Open-ended like and dislike questions were also posed, to allow respondents to comment on anything not covered by the descriptor questions.

Consumer descriptors:
Flavours: chocolate flavour intensity, sweetness, creaminess and caramel intensity (Trial 3 only)
Textures: creaminess and in-mouth residue (mouthcoating)
   Consumer Acceptability: overall liking, flavour liking, texture liking

Samples of the general population of milk chocolate consumers were used to test the chocolate (Table 16). Chocolate consumption data (frequency and preferred brand) was also collected.

TABLE 16
Number of respondents in Trials 2 and 3

| | Number of respondents (n) | |
|---|---|---|
| Population | Trial 2 | Trial 3 |
| General | 64 | 250 |
| Brand A purchasers | 24 | 110 |
| High frequency consumers (>1 weekly) | 42 | 120 |

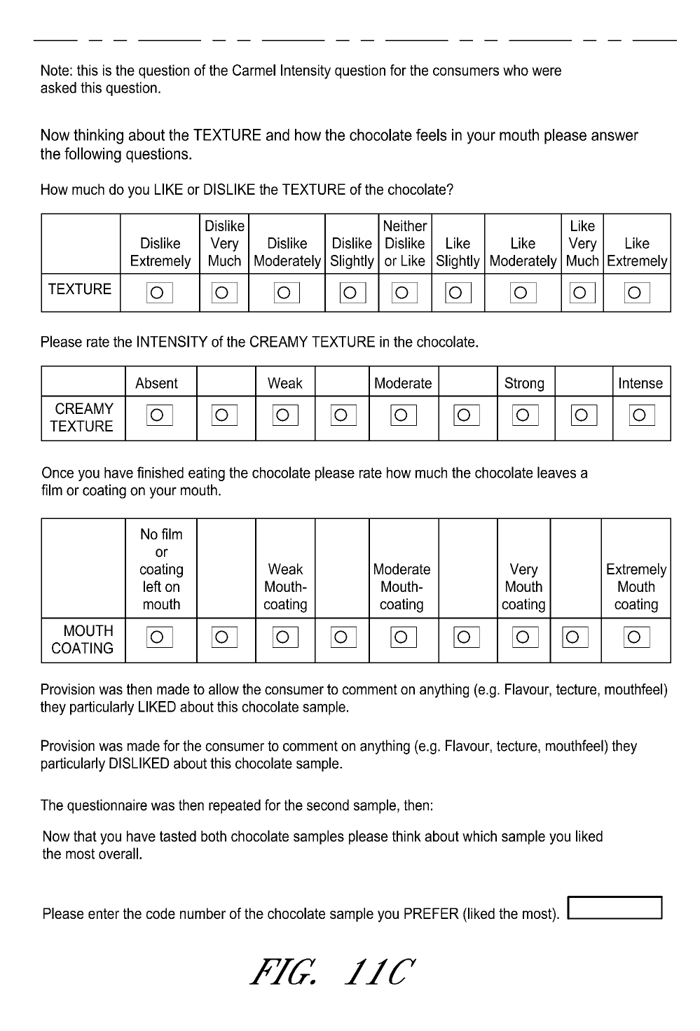

The questionnaire used in these studies is illustrated in FIG. 11.

Data analysis was carried out by ANOVA (General Linear Model) on the general population data and the sub-groups of interest (those who preferred Brand A and the high frequency consumers >1 weekly).

### Samples:

Consumers received two blind-coded samples of chocolate, being two squares (from within a block) of each sample of chocolate in foil bags which were presented in balanced order. Participants evaluated the samples and recorded their responses into an electronic questionnaire (Sawtooth software).

### Trial 2:

In Trial 2, 64 consumers compared two hand-tempered bench scale chocolate samples which were standardised for fat content using locally sourced standard anhydrous milk fat (AMF):
1. Brand A standard commercial formulation using CDBP 2. Brand A standard formulation in which 2% exemplary flavour composition DF300 and standard WMP replaced the CDBP.

### Trial 3:

In Trial 3, 250 consumers compared a sample of Brand A Milk chocolate containing standard WMP and 2% exemplary flavour composition DF300 to Brand A milk chocolate purchased from a retail store.

The exemplary flavour composition DF300 product was made with an overall lower milk fat content (WMP 26.8%) compared to the standard product made with typical 29.5% fat CDBP. This equates to a 10% reduction in total milk fat. Neither AMF nor Cocoa butter was added to make chocolate of equivalent fat content in this trial. Thus, this trial also investigated the use of flavour concentrates of the present invention in the preparation of lower fat chocolate without compromised sensory characteristics.

### Results

### Trial 2 Findings

### Overall Chocolate Acceptability

There was no statistical difference observed in preference between the chocolate comprising standard WMP and exemplary flavour composition DF300 compared with the commercial milk chocolate formulation at p<0.05 (data not shown).

No difference in either overall liking or flavour liking was observed between the chocolate formulations within the populations analysed (general population (n=64), Brand A consumers (n=24) and high frequency consumers (n=42), Table 17).

Texture liking was slightly higher for the standard chocolate compared to the chocolate comprising exemplary flavour composition DF300 for both the general population and high frequency consumers (Table 17).

### Influence of Ingredients on Flavour and Texture Attributes

Chocolate and creamy flavour intensity and sweetness were equivalent for the exemplary flavour composition 300 and standard formulations for all populations (Table 17). Also, creamy texture was slightly more intense in the standard formulation compared to exemplary flavour composition 300 for the general population (Table 19).

High frequency consumers found the chocolate comprising exemplary flavour composition DF300 slightly more mouthcoating than the standard chocolate (Table 17).

TABLE 17
Summary of Consumer Sensory Testing Data - Trial 2

| | | | Trial 2 | |
|---|---|---|---|---|
| | | | Bench Scale | |
| | | | | Exemplary flavour |
| | | | Standard | composition DF300 |
| | | | Formulation | formulated |
| Overall liking | | General population | 6.9 | 6.6 |
| | | Brand A's purchasers | 7.0 | 6.6 |
| | | High frequency consumers | 6.9 | 6.8 |
| Flavour liking | | General population | 6.7 | 6.5 |
| | | Brand A's purchasers | 6.8 | 6.4 |
| | | High frequency consumers | 6.7 | 6.7 |
| Flavour | Chocolate | General population | 5.8 | 5.7 |
| attributes | | Brand A's purchasers | 5.8 | 5.9 |
| | | High frequency consumers | 5.8 | 5.7 |
| | Sweetness | General population | 5.5 | 5.4 |
| | | Brand A's purchasers | 5.6 | 5.5 |
| | | High frequency consumers | 5.7 | 5.6 |
| | Creaminess | General population | 6.3 | 6.1 |
| | | Brand A's purchasers | 6.5 | 6.2 |
| | | High frequency consumers | 6.3 | 6.4 |
| Texture liking | | General population | 6.7^{a} | 6.1^{b} |
| | | Brand A's purchasers | 6.9 | 6.0 |
| | | High frequency consumers | 6.7^{a} | 6.1^{b} |
| Texture | Creaminess | General population | 6.4^{a} | 6.0^{b} |
| attributes | | Brand A's purchasers | 6.7 | 6.1 |
| | | High frequency consumers | 6.3 | 6.2 |
| | Mouthcoating | General population | 5.0 | 5.3 |
| | | Brand A's purchasers | 5.4 | 6.1 |
| | | High frequency consumers | 5.1^{b} | 5.6^{a} |

Differing superscript letters indicate significant difference at p < 0.05 within that row for a particular trial.

### Trial 3 Findings:

### Overall Chocolate Acceptability:

There was no statistical difference observed in either overall liking or flavour liking between the chocolate formulations within the populations analysed (general population (n=250), Brand A consumers (n=110) and high frequency consumers (n=120), Table 18).

Texture liking was slightly higher for the standard formulation in the general population and all populations perceived the standard formulation to have a slightly more creamy texture, as well as more tendency to coat the mouth (Table 18). The chocolate comprising standard WMP and exemplary flavour composition DF300 had approximately 10% less milk fat than the commercial milk chocolate to which it was compared. This reduction in milk fat to cocoa butter ratio can increase the hardness of the chocolate, and the decreased fat content can decrease the smoothness of the chocolate. Applicants believe, without wishing to be bound by any theory, that the higher fat content in the standard chocolate may have caused the higher texture scores for mouth coating and creaminess for all consumers (Table 18). Applicants believe, again without wishing to be bound by any theory, that this is responsible (at least in part) for the texture liking differences.

The textural differences and causal factors described above are assessed as the reason behind the standard formulation having a statistically significant preference difference (p<0.05) over the chocolate comprising standard WMP and exemplary flavour composition DF300 at 58.5% to 41.5% respectively.

### Influence of Ingredients on Flavour and Texture Attributes

The standard formulation was perceived to have slightly more chocolate and creamy flavour intensity than the chocolate comprising exemplary flavour composition DF300 (Table 18). Again, the higher fat content in the standard commercial chocolate is believed by Applicants, again without wishing to be bound by any theory, of having influenced these results. Sweetness was slightly increased in the chocolate comprising standard WMP and exemplary flavour composition DF300 compared to the standard formulation for the general population (Table 18).

TABLE 18
Summary of Consumer Sensory Testing Data - Trial 3

| | | | Trial 3 | |
|---|---|---|---|---|
| | | | Commercial Plant | |
| | | | | EXEMPLARY |
| | | | | FLAVOUR |
| | | | | COMPOSITION |
| | | | Standard | DF300 formulated |
| Overall liking | | General population | 6.7 | 6.6 |
| | | Brand A's purchasers | 6.8 | 6.7 |
| | | High frequency consumers | 6.9 | 6.8 |
| Flavour liking | | General population | 6.5 | 6.5 |
| | | Brand A's purchasers | 6.7 | 6.5 |
| | | High frequency consumers | 6.7 | 6.7 |
| Flavour | Chocolate | General population | 5.8^{a} | 5.3^{b} |
| attributes | | Brand A's purchasers | 6.1^{a} | 5.5^{b} |
| | | High frequency consumers | 5.8^{a} | 5.3^{b} |
| | Sweetness | General population | 5.2^{b} | 5.7^{a} |
| | | Brand A's purchasers | 5.6 | 5.9 |
| | | High frequency consumers | 5.5 | 5.8 |
| | Creaminess | General population | 5.7^{a} | 5.4^{b} |
| | | Brand A's purchasers | 5.9^{a} | 5.3^{b} |
| | | High frequency consumers | 5.9^{a} | 5.4^{b} |
| Texture liking | | General population | 6.7^{a} | 6.3^{b} |
| | | Brand A's purchasers | 6.7 | 6.5 |
| | | High frequency consumers | 6.7 | 6.5 |
| Texture | Creaminess | General population | 5.8^{a} | 5.4^{b} |
| attributes | | Brand A's purchasers | 5.9^{a} | 5.4^{b} |
| | | High frequency consumers | 5.9^{a} | 5.4^{b} |
| | Mouthcoating | General population | 5.1^{a} | 4.6^{b} |
| | | Brand A's purchasers | 5.3^{a} | 4.7^{b} |
| | | High frequency consumers | 5.1^{a} | 4.5^{b} |

Differing superscript letters indicate significant difference at p < 0.05 within that row for a particular trial.

As shown in Table 19 below, the chocolate comprising standard WIMP and exemplary flavour composition DF300 had an equivalent intensity of caramel flavour to the standard chocolate formulation (p<0.05). That is, the inclusion of exemplary flavour composition DF300 has contributed similar caramel flavour characteristics to the chocolate compared with the use of CDBP.

TABLE 19
Trial 3 Caramel Flavour intensity

| | Caramel Flavour Intensity | |
|---|---|---|
| | | Dairy Flavour 300 |
| | Standard | formulated, lower fat |
| General population (n = 121) | 4.8^{a} | 4.5^{a} |
| Brand A's purchasers (n = 50) | 4.6^{a} | 4.3^{a} |
| High frequency consumers (n = 62) | 4.6^{a} | 4.6^{a} |

Differing superscript letters indicate significant difference at p < 0.05 within that row for a particular trial.

### Conclusions

These examples shows that flavour concentrates of the present invention can substitute for Fonterra Caramelised Dairy Based Powder (CDBP) with respect to improving the caramel flavour intensity of chocolate, and may allow the preparation of chocolates having lower fat content while retaining desirable flavour. The examples also show that inclusion of examples of the exemplary flavour compositions increases the caramel flavour characteristics commonly associated with the crumb flavour in chocolate formulations made with CDBP to levels commonly associated with chocolate made using the crumb process.

### Example 12

### Use of Exemplary Flavour Concentrates in Confection

### Introduction

This example investigates the use of exemplary flavour concentrate DF400 as a flavouring agent in nougat.

### Method

Egg whites were placed in a mixing bowl and whipped to thick foam. The hot sugars were then added to the whipped egg whites while still whipping. The mixer whisk was then changed to a paddle and the palm fat (control), or DF400, fruit and nuts were added to the mixture.

The nougat was then placed on a silicon baking mat that was covered in an icing sugar and corn flour layer. The nougat was spread out and then a mix of icing sugar and corn flour was sifted on top and the nougat rolled out. The nougat was allowed to set for >24 hrs and then cut for tasting.

### Ingredients

| | |
|---|---|
| Castor sugar | 30.2% |
| Glucose syrup | 6.6% |
| Invert sugar | 18.1% |
| Egg whites | 7.3% |
| Caster sugar | 1.5% |
| Slivered almonds | 11.2% |
| Dried cranberries | 6.6% |
| DF400, or Palm fat | 6.6% |
| Water | 16.3% |

### Tasting

The samples were cut up and presented blind to an expert taste panel.

### Results

The flavour comments were recorded as:

a) Palm fat sample (control): Sugar, not oily, bland,

b) DF 400 sample: Sweet, oily, butter scotch, butter, ghee, more rounded

The samples were then presented to the expert panel to score on a 0-9 point scale and ranked out of 9 for flavour characteristics: On this scoring system, 0=Absent and 9=intense

### Average Score

| Sample | Butterscotch | Caramel | Buttery |
|---|---|---|---|
| DF 400 | 5 | 2.7 | 4 |
| Palm fat | 1 | 0.5 | 0.3 |

### CONCLUSION

The nougat made with the DF 400 had a distinctly different flavour profile to the nougat made with the palm fat. In particular, it had had more butterscotch, caramel, and buttery flavours.

### INDUSTRIAL APPLICATION

The flavour concentrates produced by the methods of the present invention have improved flavour and other characteristics and have wide application in the production of foods and beverages, particularly those where traditional flavour sources such as butter or ghee are used.

Where in the foregoing description reference has been made to elements or integers having known equivalents, then such equivalents are included as if they were individually set forth.

What we claim is:

1. Use of one or more flavour concentrates as a flavouring agent in chocolate or confectionery, wherein the one or more flavour concentrates is any one or more of a condensed flavour concentrate, a solids flavour concentrate, or has been prepared in a method of making a flavour concentrate comprising
a) providing a lipid material,
b) providing an aqueous material, the aqueous material comprising one or more sugars and one or more primary or secondary amines,
c) heating the lipid material to a first temperature at or above the boiling point of the aqueous material,
d) admixing the heated lipid material and the aqueous material, and
e) maintaining the mixture for a period at a temperature at least until substantially all the water present in the aqueous material is vapourised,
f) recovering the mixture;
wherein when present the condensed flavour concentrate has been prepared in a method of making a flavour concentrate comprising
i. heating a lipid material to a first temperature, the lipid material being substantially free of protein or water or both protein and water,
ii. adding an aqueous material to the heated lipid material to form a mixture, the aqueous material comprising one or more sugars and one or more proteins, and optionally one or more lipids, the first temperature being above the boiling point of the aqueous material, wherein at least some of the water present in the aqueous material is vapourised,
iii. extracting the vapour produced in step (b) and
iv. condensing the vapour to form the condensed flavour concentrate, and wherein when present the solids flavour concentrate has been prepared in a method comprising
(1) providing a lipid material,
(2) providing an aqueous material, the aqueous material comprising one or more sugars and one or more free amine groups,
(3) heating the lipid material to a first temperature at or above the boiling point of the aqueous material,
(4) admixing the heated lipid material and the aqueous material,
(5) maintaining the mixture for a period at a temperature at least until substantially all the water present in the aqueous material is vapourised,
(6) separating the solids from the mixture to form the solids flavour concentrate.

2. The use of claim 1 wherein the temperature at which the mixture is maintained in step (e) is at or about the first temperature, or is another temperature below or above the first temperature.

3. The use of claim 1 additionally comprising after step (e) the step:
g) maintaining the mixture for a second period at a second temperature that is different to the first temperature.

4. The use of claim 1 additionally comprising after step (e) the step:
f) maintaining the mixture for a second period at or about the first temperature.

5. The use of claim 1 wherein the aqueous material is heated at or to at least about 60 degrees Celsius prior to admixture.

6. The use of claim 1 wherein the lipid material comprises one or more of the group consisting of an edible oil, an animal fat, a dairy fat, a fish oil, a modified edible oil, a modified animal fat, a modified dairy fat, anhydrous milk fat or a mixture thereof.

7. The use of claim 1 wherein the one or more primary or secondary amines in the aqueous material are present as one or more of the group consisting of one or more amino acids, one or more peptides, or one or more proteins.

8. The use of any one of claim 1 wherein the aqueous material additionally comprises one or more lipids.

9. The use of claim 1 wherein the aqueous material is uncooked aqueous material.

10. The use of claim 1 wherein the aqueous material is selected from the group comprising soy bean milk, soy bean protein, or a reconstituted, recombined, fermented or fresh dairy material.

11. The use of claim 10 wherein the dairy material is selected from the group comprising recombined or fresh whole milk, recombined or fresh skim milk, reconstituted whole milk powder, reconstituted skim milk powder, skim milk concentrate, skim milk retentate, concentrated milk, cultured milk, yoghurt, kefir, ultrafiltered milk retentate, milk protein concentrate, milk protein isolate, calcium depleted milk protein concentrate, low fat milk, low fat milk protein concentrate, casein, caseinate, cream, cultured cream, butter milk, butter serum, a dairy fermentate, whey, whey cream, whey protein concentrate, or cultured whey cream.

12. The use of claim 10 wherein the aqueous material is a cultured dairy material.

13. The use of claim 12 wherein the culture source is a fermentate produced using acid-producing bacteria.

14. The use of claim 1 wherein one or more of the flavour concentrates comprises one or more flavour characteristics selected from toffee flavour, butterscotch flavour, baked biscuit flavour, caramel flavour, and malt flavour, flavours associated with roasted nuts, heated/roasted popcorn, fried potato chips, baked unleavened breads, flavours associated with roasted meat or cooked pizza, or a blue cheese flavour.

15. Use of one or more flavour concentrates as a flavouring agent in chocolate or confectionery, wherein the one or more flavour concentrates comprises a cooked mixture of a lipid material and an aqueous material, wherein the lipid material is selected from the group comprising one or more dairy fats, one or more dairy oils, one or more animal fats, one or more animal oils, one or more vegetable fats, or one or more vegetable oils, and a combination thereof, the aqueous material comprises one or more sugars and one or more free amine groups, and optionally one or more lipids, and
wherein the composition comprises at least one of the compounds selected from the group consisting of
10-100 μg/g furfural,
0.1-10 μg/g 3,4-dihydroxyhex-3-ene-2,5-dione,
10-100 μg/g maltol,
0.1-10 μg/g furaneol,
2.5-30 μg/g acetol,
1-5 μg/g pentan-2-one,
1-35 μg/g heptan-2-one,
0.1-100 μg/g 3-methylbutanal, or
0.1-10 μg/g 2-methylbutanal.

16. A chocolate or confection comprising one or more flavour concentrates wherein the one or more flavour concentrates is any one or more of a condensed flavour concentrate, a solids flavour concentrate, or has been prepared in a method of making a flavour concentrate comprising
a) providing a lipid material,
b) providing an aqueous material, the aqueous material comprising one or more sugars and one or more primary or secondary amines,
c) heating the lipid material to a first temperature at or above the boiling point of the aqueous material,
d) admixing the heated lipid material and the aqueous material, and
e) maintaining the mixture for a period at a temperature at least until substantially all the water present in the aqueous material is vapourised,
f) recovering the mixture;
wherein when present the condensed flavour concentrate has been prepared in a method of making a flavour concentrate comprising
i. heating a lipid material to a first temperature, the lipid material being substantially free of protein or water or both protein and water,
ii. adding an aqueous material to the heated lipid material to form a mixture, the aqueous material comprising one or more sugars and one or more proteins, and optionally one or more lipids, the first temperature being above the boiling point of the aqueous material, wherein at least some of the water present in the aqueous material is vapourised,
iii. extracting the vapour produced in step (b) and
iv. condensing the vapour to form the condensed flavour concentrate.
and wherein when present the solids flavour concentrate has been prepared in a method comprising
(1) providing a lipid material,
(2) providing an aqueous material, the aqueous material comprising one or more sugars and one or more free amine groups,
(3) heating the lipid material to a first temperature at or above the boiling point of the aqueous material,
(4) admixing the heated lipid material and the aqueous material,
(5) maintaining the mixture for a period at a temperature at least until substantially all the water present in the aqueous material is vapourised,
(6) separating the solids from the mixture to form the solids flavour concentrate.

17. A chocolate or confection comprising one or more flavour concentrates wherein
the one or more flavour concentrates comprises a cooked mixture of a lipid material and an aqueous material, wherein
the lipid material is selected from the group comprising one or more dairy fats, one or more dairy oils, one or more animal fats, one or more animal oils, one or more vegetable fats, or one or more vegetable oils, and a combination thereof,
the aqueous material comprises one or more sugars and one or more free amine groups, and optionally one or more lipids, and
wherein the composition comprises at least one of the compounds selected from the group consisting of
10-100 μg/g furfural,
0.1-10 μg/g 3,4-dihydroxyhex-3-ene-2,5-dione,
10-100 μg/g maltol,
0.1-10 μg/g furaneol,
2.5-30 μg/g acetol,
1-5 μg/g pentan-2-one,
1-35 μg/g heptan-2-one,
0.1-100 μg/g 3-methylbutanal, or
0.1-10 μg/g 2-methylbutanal.

18. The confection of claim 17 wherein the confection is or comprises nougat.
